(19) United States
(12) Patent Application Publication
(10) Pub. No.: US 2015/0068130 A1
(43) Pub. Date: Mar. 12, 2015

(54) ABRASIVE ARTICLE INCLUDING SHAPED ABRASIVE PARTICLES

(71) Applicant: Saint-Gobain Ceramics & Plastics, Inc., Worcester, MA (US)

(72) Inventors: David Louapre, Newton, MA (US); Kristin Breder, Belchertown, MA (US); Sujatha Iyengar, Northborough, MA (US); Adam D. Lior, Brookline, MA (US)

(21) Appl. No.: 14/318,544

(22) Filed: Jun. 27, 2014

Related U.S. Application Data
(60) Provisional application No. 61/841,155, filed on Jun. 28, 2013.

(51) Int. Cl. C09K 3/14; B24D 11/00

(52) U.S. Cl. CPC C09K 3/1409; B24D 11/00
USPC 51/309

(57) ABSTRACT

A shaped abrasive particle having a major surface-to-side surface grinding orientation percent difference (MSGPD) of at least about 40%.

### CROSS-REFERENCE TO RELATED APPLICATION

This application claims priority under 35 U.S.C. §119(e) to U.S. Patent Application No. 61/841,155 entitled “Abrasive Articles Including Shaped Abrasive Particles” by David Louapre et al., filed Jun. 28, 2013, which is assigned to the current assignee hereof and incorporated herein by reference in its entirety.

### BACKGROUND

1. Field of the Disclosure

The following is directed to abrasive articles, and particularly, abrasive articles including shaped abrasive particles.

2. Description of the Related Art

Abrasive particles and abrasive articles made from abrasive particles are useful for various material removal operations including grinding, finishing, and polishing. Depending upon the type of abrasive material, such abrasive particles can be useful in shaping or grinding a wide variety of materials and surfaces in the manufacturing of goods. Certain types of abrasive particles have been formulated to date that have particular geometries, such as triangular shaped abrasive particles and abrasive articles incorporating such objects. See, for example, U.S. Pat. Nos. 5,201,916; 5,366,523; and 5,984,988.

Three basic technologies that have been employed to produce abrasive particles having a specified shape are (1) fusion, (2) sintering, and (3) chemical ceramic. In the fusion process, abrasive particles can be shaped by a chill roll, the face of which may or may not be engraved, a mold into which molten material is poured, or a heat sink material immersed in an aluminum oxide melt. See, for example, U.S. Pat. No. 3,377,660 (disclosing a process including flowing molten abrasive material from a furnace onto a cool rotating casting cylinder, rapidly solidifying the material to form a thin semisolid curved sheet, densifying the semisolid material with a pressure roll, and then partially fracturing the strip of semisolid material by reversing its curvature by pulling it away from the cylinder with a rapidly driven cooled conveyor).

In the sintering process, abrasive particles can be formed from refractory powders having a particle size of up to 10 micrometers in diameter. Binders can be added to the powders along with a lubricant and a suitable solvent, e.g., water. The resulting mixture, mixtures, or slurries can be shaped into platelets or rods of various lengths and diameters. See, for example, U.S. Pat. No. 3,079,242 (disclosing a method of making abrasive particles from calcined bauxite material including (1) reducing the material to a fine powder, (2) compacting under affirmative pressure and forming the fine particles of said powder into grain sized agglomerations, and (3) sintering the agglomerations of particles at a temperature below the fusion temperature of the bauxite to induce limited recrystallization of the particles, whereby abrasive grains are produced directly to size).

Chemical ceramic technology involves converting a colloidal dispersion or hydrosol (sometimes called a sol), optionally in a mixture, with solutions of other metal oxide precursors, into a gel or any other physical state that restrains the mobility of the components, drying, and firing to obtain a ceramic material. See, for example, U.S. Pat. Nos. 4,744,802 and 4,848,041.

Still, there remains a need in the industry for improving performance, life, and efficacy of abrasive particles, and the abrasive articles that employ abrasive particles.

### SUMMARY

In one aspect, a shaped abrasive particle comprises a major surface-to-side surface grinding orientation percent difference (MSGPD) of at least about 40%.

In another aspect, a shaped abrasive particle comprises a maximum quartile-to-median percent difference (MQMPD) of at least about 48%.

In yet another aspect, a batch of abrasive particles comprises a first portion including a plurality of shaped abrasive particles having a major surface-to-side surface grinding orientation percent difference (MSGPD) of at least about 40%.

For another aspect, a batch of abrasive particles comprises a first portion including a plurality of shaped abrasive particles having a maximum quartile-to-median percent difference (MQMPD) of at least about 48%.

In still another aspect, a shaped abrasive particle comprises a major surface grinding efficiency median value (MSM) of not greater than about 4 kN/mm2.

According to yet another aspect, an abrasive article comprises a backing, a batch of abrasive particles comprising a first portion including a plurality of shaped abrasive particles overlying the backing. Wherein the plurality of shaped abrasive particles of the first portion include at least one first grinding efficiency characteristic of a major surface-to-side surface grinding orientation percent difference (MSGPD) of at least about 40%, a maximum quartile-to-median percent difference (MQMPD) of at least about 48%, a major surface grinding efficiency median value (MSM) of not greater than about 4 kN/mm², and a combination thereof.

In still one aspect, a method includes removing material from a workpiece by moving an abrasive article relative to a surface of the workpiece, the abrasive article includes a backing and a batch of abrasive particles comprising a first portion including a plurality of shaped abrasive particles overlying the backing, wherein the plurality of shaped abrasive particles of the first portion comprise at least one first grinding efficiency characteristic of a major surface-to-side surface grinding orientation percent difference (MSGPD) of at least about 40%, a maximum quartile-to-median percent difference (MQMPD) of at least about 48%, a major surface grinding efficiency median value (MSM) of not greater than about 4 kN/mm², and a combination thereof.

### BRIEF DESCRIPTION OF THE DRAWINGS

The present disclosure may be better understood, and its numerous features and advantages made apparent to those skilled in the art by referencing the accompanying drawings.

FIG. 1A includes a portion of a system for forming a particulate material in accordance with an embodiment.

FIG. 1B includes a portion of the system of FIG. 1A for forming a particulate material in accordance with an embodiment.

FIG. 2 includes a portion of a system for forming a particulate material in accordance with an embodiment.

FIG. 3A includes a perspective view illustration of a shaped abrasive particle according to an embodiment

FIG. 3B includes a cross-sectional illustration of the shaped abrasive particle of FIG. 3A.

FIG. 4 includes a side view of a shaped abrasive particle and percentage flashing according to an embodiment.

FIG. 5 includes a cross-sectional illustration of a portion of a coated abrasive article according to an embodiment.

FIG. 6 includes a cross-sectional illustration of a portion of a coated abrasive article according to an embodiment.

FIG. 7A includes an illustration of a top-view of a major surface of a shaped abrasive particle according to an embodiment.

FIG. 7B includes an illustration of a side-view of a side surface of a shaped abrasive particle according to an embodiment.

FIG. 8 includes a generalized plot of force per total area removed from the workpiece, which is representative of data derived from the SGGT.

FIG. 9 includes a perspective view illustration of a portion of an abrasive article including shaped abrasive particles having predetermined orientation characteristics relative to a grinding direction in accordance with an embodiment.

FIG. 10 includes an image of two representative shaped abrasive particles from Sample 51.

FIG. 11 includes an image of two representative shaped abrasive particles from Sample CS2

FIG. 12 includes an image of two representative shaped abrasive particles from Sample S3.

FIG. 13 includes an image of two representative shaped abrasive particles from Sample S4.

FIG. 14 includes an image of two representative shaped abrasive particles from Sample CS1.

FIG. 15 includes a plot of major surface grinding efficiency and side surface grinding efficiency according to the SGGT for a conventional sample of shaped abrasive particles and shaped abrasive particles representative of the embodiments herein.

FIG. 16 includes images representative of portions of a coated abrasive according to an embodiment and used to analyze the orientation of shaped abrasive particles on the backing.

FIG. 17 includes a plot includes a plot of major surface grinding efficiency over time according to the SGGT for a shaped abrasive particles representative of an embodiments herein.

### DETAILED DESCRIPTION

The following is directed to abrasive articles including, for example, fixed abrasive articles such as coated abrasive articles. The abrasive articles can include shaped abrasive particles. Various other uses may be derived for the shaped abrasive particles. Certain aspects of the embodiments herein are directed to grinding characteristics of the coated abrasive articles, and such characteristics are not to be interpreted as limiting the intended purpose or potential applications of the coated abrasive articles. Rather, the one or more grinding characteristics are quantifiable features of the coated abrasive articles according to known test conditions to demonstrate the advantages of the coated abrasive articles of the embodiments over conventional articles.

Shaped Abrasive Particles

Various methods may be utilized to obtain shaped abrasive particles. The particles may be obtained from a commercial source or fabricated. Various suitable processes may be used to fabricate the shaped abrasive particles including, but not limited to, screen-printing, molding, pressing, casting, sectioning, cutting, dicing, punching, drying, curing, depositing, coating, extruding, rolling, and a combination thereof.

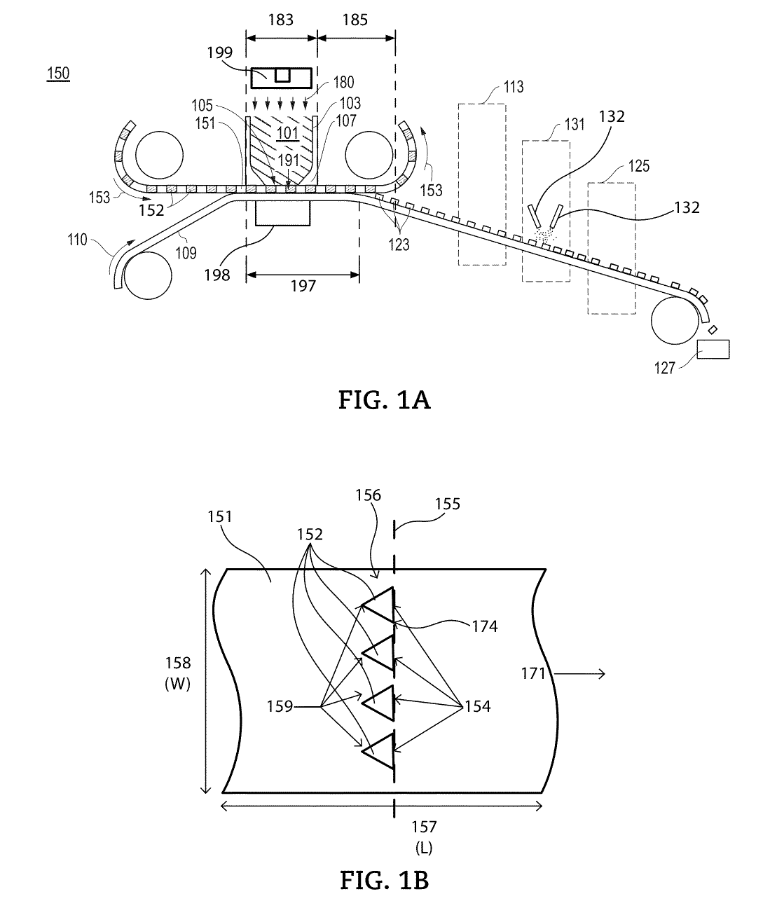

FIG. 1A includes an illustration of a system 150 for forming a shaped abrasive particle in accordance with one, non-limiting embodiment. The process of forming shaped abrasive particles can be initiated by forming a mixture 101 including a ceramic material and a liquid. In particular, the mixture 101 can be a gel formed of a ceramic powder material and a liquid, wherein the gel can be characterized as a shape-stable material having the ability to substantially hold a given shape even in the green (i.e., unfired) state. In accordance with an embodiment, the gel can be formed of the ceramic powder material as an integrated network of discrete particles.

The mixture 101 may contain a certain content of solid material, liquid material, and additives such that it has suitable rheological characteristics for use with the process detailed herein. That is, in certain instances, the mixture can have a certain viscosity, and more particularly, suitable rheological characteristics that form a dimensionally stable phase of material that can be formed through the process as noted herein. A dimensionally stable phase of material is a material that can be formed to have a particular shape and substantially maintain the shape for at least a portion of the processing subsequent to forming. In certain instances, the shape may be retained throughout subsequent processing, such that the shape initially provided in the forming process is present in the finally-formed object.

The mixture 101 can be formed to have a particular content of solid material, such as the ceramic powder material. For example, in one embodiment, the mixture 101 can have a solids content of at least about 25 wt %, such as at least about 35 wt %, or even at least about 38 wt % for the total weight of the mixture 101. Still, in at least one non-limiting embodiment, the solids content of the mixture 101 can be not greater than about 75 wt %, such as not greater than about 70 wt %, not greater than about 65 wt %, not greater than about 55 wt %, not greater than about 45 wt %, or not greater than about 42 wt %. It will be appreciated that the content of the solids materials in the mixture 101 can be within a range between any of the minimum and maximum percentages noted above.

According to one embodiment, the ceramic powder material can include an oxide, a nitride, a carbide, a boride, an oxycarbide, an oxynitride, and a combination thereof. In particular instances, the ceramic material can include alumina. More specifically, the ceramic material may include a boehmite material, which may be a precursor of alpha alumina. The term “boehmite” is generally used herein to denote alumina hydrates including mineral boehmite, typically being Al₂O₃.H₂O and having a water content on the order of 15%, as well as pseudoboehmite, having a water content higher than 15%, such as 20-38% by weight. It is noted that boehmite (including pseudoboehmite) has a particular and identifiable crystal structure, and therefore a unique X-ray diffraction pattern. As such, boehmite is distinguished from other aluminous materials including other hydrated aluminas such as ATH (aluminum trihydroxide), a common precursor material used herein for the fabrication of boehmite particulate materials.

Furthermore, the mixture 101 can be formed to have a particular content of liquid material. Some suitable liquids may include water. In accordance with one embodiment, the mixture 101 can be formed to have a liquid content less than the solids content of the mixture 101. In more particular instances, the mixture 101 can have a liquid content of at least about 25 wt % for the total weight of the mixture 101. In other instances, the amount of liquid within the mixture 101 can be greater, such as at least about 35 wt %, at least about 45 wt %, at least about 50 wt %, or even at least about 58 wt %. Still, in at least one non-limiting embodiment, the liquid content of the mixture can be not greater than about 75 wt %, such as not greater than about 70 wt %, not greater than about 65 wt %, not greater than about 62 wt %, or even not greater than about 60 wt %. It will be appreciated that the content of the liquid in the mixture 101 can be within a range between any of the minimum and maximum percentages noted above.

Furthermore, to facilitate processing and forming shaped abrasive particles according to embodiments herein, the mixture 101 can have a particular storage modulus. For example, the mixture 101 can have a storage modulus of at least about 1×10⁴ Pa, such as at least about 4×10⁴ Pa, or even at least about 5×10⁴ Pa. However, in at least one non-limiting embodiment, the mixture 101 may have a storage modulus of not greater than about 1×10′ Pa, such as not greater than about 2×10⁶ Pa. It will be appreciated that the storage modulus of the mixture 101 can be within a range between any of the minimum and maximum values noted above.

The storage modulus can be measured via a parallel plate system using ARES or AR-G2 rotational rheometers, with Peltier plate temperature control systems. For testing, the mixture 101 can be extruded within a gap between two plates that are set to be approximately 8 mm apart from each other. After extruding the gel into the gap, the distance between the two plates defining the gap is reduced to 2 mm until the mixture 101 completely fills the gap between the plates. After wiping away excess mixture, the gap is decreased by 0.1 mm and the test is initiated. The test is an oscillation strain sweep test conducted with instrument settings of a strain range between 0.01% to 100%, at 6.28 rad/s (1 Hz), using 25-mm parallel plate and recording 10 points per decade. Within 1 hour after the test completes, the gap is lowered again by 0.1 mm and the test is repeated. The test can be repeated at least 6 times. The first test may differ from the second and third tests. Only the results from the second and third tests for each specimen should be reported.

Furthermore, to facilitate processing and forming shaped abrasive particles according to embodiments herein, the mixture 101 can have a particular viscosity. For example, the mixture 101 can have a viscosity of at least about 4×10³ Pa s, at least about 5×10³ Pa s, at least about 6×10³ Pa s, at least about 8×10³ Pa s, at least about 10×10³ Pa s, at least about 20×10³ Pa s, at least about 30×10³ Pa s, at least about 40×10³ Pa s, at least about 50×10³ Pa s, at least about 60×10³ Pa s, or at least about 65×10³ Pa s. In at least one non-limiting embodiment, the mixture 101 may have a viscosity of not greater than about 100×10³ Pa s, such as not greater than about 95×10³ Pa s, not greater than about 90×10³ Pa s, or even not greater than about 85×10³ Pa s. It will be appreciated that the viscosity of the mixture 101 can be within a range between any of the minimum and maximum values noted above. The viscosity can be measured in the same manner as the storage modulus as described above.

Moreover, the mixture 101 can be formed to have a particular content of organic materials including, for example, organic additives that can be distinct from the liquid to facilitate processing and formation of shaped abrasive particles according to the embodiments herein. Some suitable organic additives can include stabilizers, binders such as fructose, sucrose, lactose, glucose, UV curable resins, and the like.

Notably, the embodiments herein may utilize a mixture 101 that can be distinct from slurries used in conventional forming operations. For example, the content of organic materials within the mixture 101 and, in particular, any of the organic additives noted above, may be a minor amount as compared to other components within the mixture 101. In at least one embodiment, the mixture 101 can be formed to have not greater than about 30 wt % organic material for the total weight of the mixture 101. In other instances, the amount of organic materials may be less, such as not greater than about 15 wt %, not greater than about 10 wt %, or even not greater than about 5 wt %. Still, in at least one non-limiting embodiment, the amount of organic materials within the mixture 101 can be at least about 0.01 wt %, such as at least about 0.5 wt % for the total weight of the mixture 101. It will be appreciated that the amount of organic materials in the mixture 101 can be within a range between any of the minimum and maximum values noted above.

Moreover, the mixture 101 can be formed to have a particular content of acid or base, distinct from the liquid content, to facilitate processing and formation of shaped abrasive particles according to the embodiments herein. Some suitable acids or bases can include nitric acid, sulfuric acid, citric acid, chloric acid, tartaric acid, phosphoric acid, ammonium nitrate, and ammonium citrate. According to one particular embodiment in which a nitric acid additive is used, the mixture 101 can have a pH of less than about 5, and more particularly, can have a pH within a range between about 2 and about 4.

The system 150 of FIG. 1A, can include a die 103. As illustrated, the mixture 101 can be provided within the interior of the die 103 and configured to be extruded through a die opening 105 positioned at one end of the die 103. As further illustrated, extruding can include applying a force 180 (such as a pressure) on the mixture 101 to facilitate extruding the mixture 101 through the die opening 105. In an embodiment, the system 150 can generally be referred to as a screen printing process. During extrusion within an application zone 183, a screen 151 can be in direct contact with a portion of a belt 109. The screen printing process can include extruding the mixture 101 from the die 103 through the die opening 105 in a direction 191. In particular, the screen printing process may utilize the screen 151 such that, upon extruding the mixture 101 through the die opening 105, the mixture 101 can be forced into an opening 152 in the screen 151.

In accordance with an embodiment, a particular pressure may be utilized during extrusion. For example, the pressure can be at least about 10 kPa, such as at least about 500 kPa. Still, in at least one non-limiting embodiment, the pressure utilized during extrusion can be not greater than about 4 MPa. It will be appreciated that the pressure used to extrude the mixture 101 can be within a range between any of the minimum and maximum values noted above. In particular instances, the consistency of the pressure delivered by a piston 199 may facilitate improved processing and formation of shaped abrasive particles. Notably, controlled delivery of consistent pressure across the mixture 101 and across the width of the die 103 can facilitate improved processing control and improved dimensional characteristics of the shaped abrasive particles.

Referring briefly to FIG. 1B, a portion of the screen 151 is illustrated. As shown, the screen 151 can include the opening 152, and more particularly, a plurality of openings 152 extending through the volume of the screen 151. In accordance with an embodiment, the openings 152 can have a two-dimensional shape as viewed in a plane defined by the length (l) and width (w) of the screen. The two-dimensional shape can include various shapes such as, for example, polygons, ellipsoids, numerals, Greek alphabet letters, Latin alphabet letters, Russian alphabet characters, complex shapes including a combination of polygonal shapes, and a combination thereof. In particular instances, the openings 152 may have two-dimensional polygonal shapes such as a triangle, a rectangle, a quadrilateral, a pentagon, a hexagon, a heptagon, an octagon, a nonagon, a decagon, and a combination thereof.

As further illustrated, the screen 151 can have openings 152 that are oriented in a particular manner relative to each other. As illustrated and in accordance with one embodiment, each of the openings 152 can have substantially the same orientation relative to each other, and substantially the same orientation relative to the surface of the screen. For example, each of the openings 152 can have a first edge 154 defining a first plane 155 for a first row 156 of the openings 152 extending laterally across a lateral axis 158 of the screen 151. The first plane 155 can extend in a direction substantially orthogonal to a longitudinal axis 157 of the screen 151. However, it will be appreciated, that in other instances, the openings 152 need not necessarily have the same orientation relative to each other.

Moreover, the first row 156 of openings 152 can be oriented relative to a direction of translation to facilitate particular processing and controlled formation of shaped abrasive particles. For example, the openings 152 can be arranged on the screen 151 such that the first plane 155 of the first row 156 defines an angle relative to the direction of translation 171. As illustrated, the first plane 155 can define an angle that is substantially orthogonal to the direction of translation 171. Still, it will be appreciated that in one embodiment, the openings 152 can be arranged on the screen 151 such that the first plane 155 of the first row 156 defines a different angle with respect to the direction of translation, including for example, an acute angle or an obtuse angle. Still, it will be appreciated that the openings 152 may not necessarily be arranged in rows. The openings 152 may be arranged in various particular ordered distributions with respect to each other on the screen 151, such as in the form of a two-dimensional pattern. Alternatively, the openings may be disposed in a random manner on the screen 151.

Referring again to FIG. 1A, after forcing the mixture 101 through the die opening 105 and a portion of the mixture 101 through the openings 152 in the screen 151, one or more precursor shaped abrasive particles 123 may be printed on the belt 109 disposed under the screen 151. According to a particular embodiment, the precursor shaped abrasive particles 123 can have a shape substantially replicating the shape of the openings 152. Notably, the mixture 101 can be forced through the screen in rapid fashion, such that the average residence time of the mixture 101 within the openings 152 can be less than about 2 minutes, less than about 1 minute, less than about 40 seconds, or even less than about 20 seconds. In particular non-limiting embodiments, the mixture 101 may be substantially unaltered during printing as it travels through the screen openings 152, thus experiencing no change in the amount of components from the original mixture, and may experience no appreciable drying in the openings 152 of the screen 151.

Additionally, the system 151 can include a bottom stage 198 within the application zone 183. During the process of forming shaped abrasive particles, the belt 109 can travel over the bottom stage 198, which can offer a suitable substrate for forming. According to one embodiment, the bottom stage 198 can include a particularly rigid construction including, for example, an inorganic material such as a metal or metal alloy having a construction suited to facilitating the formation of shaped abrasive particles according to embodiments herein. Moreover, the bottom stage 198 can have an upper surface that is in direct contact with the belt 109 and that has a particular geometry and/or dimension (e.g., flatness, surface roughness, etc.), which can also facilitate improved control of dimensional characteristics of the shaped abrasive particles.

During operation of the system 150, the screen 151 can be translated in a direction 153 while the belt 109 can be translated in a direction 110 substantially similar to the direction 153, at least within the application zone 183, to facilitate a continuous printing operation. As such, the precursor shaped abrasive particles 123 may be printed onto the belt 109 and translated along the belt 109 to undergo further processing. It will be appreciated that such further processing can include processes described in the embodiments herein, including for example, shaping, application of other materials (e.g., dopant material), drying, and the like.

In some embodiments, the belt 109 and/or the screen 151 can be translated while extruding the mixture 101 through the die opening 105. As illustrated in the system 100, the mixture 101 may be extruded in a direction 191. The direction of translation 110 of the belt 109 and/or the screen 151 can be angled relative to the direction of extrusion 191 of the mixture 101. While the angle between the direction of translation 110 and the direction of extrusion 191 is illustrated as substantially orthogonal in the system 100, other angles are contemplated, including for example, an acute angle or an obtuse angle.

The belt 109 and/or the screen 151 may be translated at a particular rate to facilitate processing. For example, the belt 109 and/or the screen 151 may be translated at a rate of at least about 3 cm/s. In other embodiments, the rate of translation of the belt 109 and/or the screen 151 may be greater, such as at least about 4 cm/s, at least about 6 cm/s, at least about 8 cm/s, or even at least about 10 cm/s. Still, in at least one non-limiting embodiment, the belt 109 and/or the screen 151 may be translated in a direction 110 at a rate of not greater than about 5 m/s, not greater than about 1 m/s, or even not greater than about 0.5 m/s. It will be appreciated that the belt 109 and/or the screen 151 may be translated at a rate within a range between any of the minimum and maximum values noted above, and moreover, may be translated at substantially the same rate relative to each other. Furthermore, for certain processes according to embodiments herein, the rate of translation of the belt 109 as compared to the rate of extrusion of the mixture 101 in the direction 191 may be controlled to facilitate proper processing.

After the mixture 101 is extruded through the die opening 105, the mixture 101 may be translated along the belt 109 under a knife edge 107 attached to a surface of the die 103. The knife edge 107 may define a region at the front of the die 103 that facilitates displacement of the mixture 101 into the openings 152 of the screen 151.

Certain processing parameters may be controlled to facilitate formation of particular features of the precursor shaped abrasive particles 123 and the finally-formed shaped abrasive particles described herein. Some exemplary process parameters that can be controlled include a release distance 197, a viscosity of the mixture, a storage modulus of the mixture, mechanical properties of the bottom stage, geometric or dimensional characteristics of the bottom stage, thickness of the screen, rigidity of the screen, a solid content of the mixture, a carrier content of the mixture, a release angle, a translation speed, a temperature, a content of release agent, a pressure exerted on the mixture, a speed of the belt, and a combination thereof.

According to one embodiment, one particular process parameter can include controlling the release distance 197 between a filling position and a release position. In particular, the release distance 197 can be a distance measured in a direction 110 of the translation of the belt 109 between the end of the die 103 and the initial point of separation between the screen 151 and the belt 109. According to one embodiment, controlling the release distance 197 can affect at least one dimensional characteristic of the precursor shaped abrasive particles 123 or the finally-formed shaped abrasive particles. Moreover, control of the release distance 197 can affect a combination of dimensional characteristics of the shaped abrasive particles, including but not limited to, length, width, interior height (hi), variation of interior height (Vhi), difference in height, profile ratio, flashing index, dishing index, rake angle, any of the dimensional characteristic variations of the embodiments herein, and a combination thereof.

According to one embodiment, the release distance 197 can be not greater than a length of the screen 151. In other instances, the release distance 197 can be not greater than a width of the screen 151. Still, in one particular embodiment, the release distance 197 can be not greater than 10 times a largest dimension of the opening 152 in the screen 151. For example, the openings 152 can have a triangular shape, such as illustrated in FIG. 1B, and the release distance 197 can be not greater than 10 times the length of one side of the opening 152 defining the triangular shape. In other instances, the release distance 197 can be less, such as not greater than about 8 times the largest dimension of the opening 152 in the screen 151, such as not greater than about 5 times, not greater than about 3 times, not greater than about 2 times, or even not greater than the largest dimension of the opening 152 in the screen 151.

In more particular instances, the release distance 197 can be not greater than about 30 mm, such as not greater than about 20 mm, or even not greater than about 10 mm. For at least one embodiment, the release distance can be substantially zero, and more particularly, can be essentially zero. Accordingly, the mixture 101 can be disposed into the openings 152 within the application zone 183 and the screen 151 and the belt 109 may be separating from each other at the end of the die 103 or even before the end of the die 103.

According to one particular method of forming, the release distance 197 can be essentially zero, which may facilitate substantially simultaneous filling of the openings 152 with the mixture 101 and separation between the belt 109 and the screen 151. For example, before the screen 151 and the belt 109 pass the end of the die 103 and exit the application zone 183, separation of the screen 151 and the belt 109 may be initiated. In more particular embodiments, separation between the screen 151 and the belt 109 may be initiated immediately after the openings 152 are filled with the mixture 101, prior to leaving the application zone 183 and while the screen 151 is located under the die 103. In still another embodiment, separation between the screen 151 and the belt 109 may be initiated while the mixture 101 is being placed within the opening 152 of the screen 151. In an alternative embodiment, separation between the screen 151 and the belt 109 can be initiated before the mixture 101 is placed in the openings 152 of the screen 151. For example, before the openings 152 pass under the die opening 105, the belt 109 and screen 151 are being separated, such that a gap exists between belt 109 and the screen 151 while the mixture 101 is being forced into the openings 152.

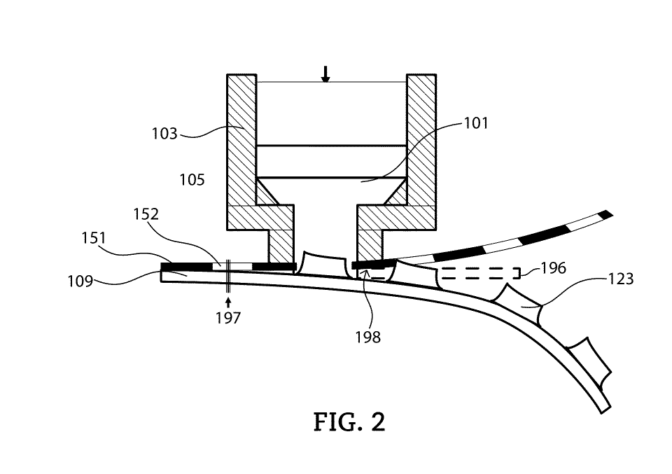

For example, FIG. 2 illustrates a printing operation where the release distance 197 is substantially zero and separation between the belt 109 and the screen 151 is initiated before the belt 109 and screen 151 pass under the die opening 105. More particularly, the release between the belt 109 and the screen 151 is initiated as the belt 109 and screen 151 enter the application zone 183 and pass under the front of the die 103. Still, it will be appreciated that in some embodiments, separation of the belt 109 and screen 151 can occur before the belt 109 and screen 151 enter the application zone 183 (defined by the front of the die 103), such that the release distance 197 may be a negative value.

Control of the release distance 197 can facilitate controlled formation of shaped abrasive particles having improved dimensional characteristics and improved dimensional tolerances (e.g., low dimensional characteristic variability). For example, decreasing the release distance 197 in combination with controlling other processing parameters can facilitate improved formation of shaped abrasive particles having greater interior height (hi) values.

Additionally, as illustrated in FIG. 2, control of the separation height 196 between a surface of the belt 109 and a lower surface 198 of the screen 151 may facilitate controlled formation of shaped abrasive particles having improved dimensional characteristics and improved dimensional tolerances (e.g., low dimensional characteristic variability). The separation height 196 may be related to the thickness of the screen 151, the distance between the belt 109 and the die 103, and a combination thereof. Moreover, one or more dimensional characteristics (e.g., interior height) of the precursor shaped abrasive particles 123 may be controlled by controlling the separation height 196 and the thickness of the screen 151. In particular instances, the screen 151 can have an average thickness of not greater than about 700 microns, such as not greater than about 690 microns, not greater than about 680 microns, not greater than about 670 microns, not greater than about 650 microns, or not greater than about 640 microns. Still, the average thickness of the screen can be at least about 100 microns, such as at least about 300 microns, or even at least about 400 microns.

In one embodiment the process of controlling can include a multi-step process that can include measuring, calculating, adjusting, and a combination thereof. Such processes can be applied to the process parameter, a dimensional characteristic, a combination of dimensional characteristics, and a combination thereof. For example, in one embodiment, controlling can include measuring one or more dimensional characteristics, calculating one or more values based on the process of measuring the one or more dimensional characteristics, and adjusting one or more process parameters (e.g., the release distance 197) based on the one or more calculated values. The process of controlling, and particularly any of the processes of measuring, calculating, and adjusting may be completed before, after, or during the formation of the shaped abrasive particles. In one particular embodiment, the controlling process can be a continuous process, wherein one or more dimensional characteristics are measured and one or more process parameters are changed (i.e., adjusted) in response to the measured dimensional characteristics. For example, the process of controlling can include measuring a dimensional characteristic such as a difference in height of the precursor shaped abrasive particles 123, calculating a difference in height value of the precursor shaped abrasive particles 123, and changing the release distance 197 to change the difference in height value of the precursor shaped abrasive particles 123.

Referring again to FIG. 1, after extruding the mixture 101 into the openings 152 of the screen 151, the belt 109 and the screen 151 may be translated to a release zone 185 where the belt 109 and the screen 151 can be separated to facilitate the formation of the precursor shaped abrasive particles 123. In accordance with an embodiment, the screen 151 and the belt 109 may be separated from each other within the release zone 185 at a particular release angle.

In fact, as illustrated, the precursor shaped abrasive particles 123 may be translated through a series of zones wherein various treating processes may be conducted. Some suitable exemplary treating processes can include drying, heating, curing, reacting, radiating, mixing, stirring, agitating, planarizing, calcining, sintering, comminuting, sieving, doping, and a combination thereof. According to one embodiment, the precursor shaped abrasive particles 123 may be translated through an optional shaping zone 113, wherein at least one exterior surface of the particles may be shaped as described in embodiments herein. Furthermore, the precursor shaped abrasive particles 123 may be translated through an optional application zone 131, wherein a dopant material can be applied to at least one exterior surface of the particles as described in embodiments herein. And further, the precursor shaped abrasive particles 123 may be translated on the belt 109 through an optional post-forming zone 125, wherein a variety of processes, including for example, drying, may be conducted on the precursor shaped abrasive particles 123 as described in embodiments herein.

The application zone 131 may be used for applying a material to at least one exterior surface of one or more precursor shaped abrasive particles 123. In accordance with an embodiment, a dopant material may be applied to the precursor shaped abrasive particles 123. More particularly, as illustrated in FIG. 1, the application zone 131 can be positioned before the post-forming zone 125. As such, the process of applying a dopant material may be completed on the precursor shaped abrasive particles 123. However, it will be appreciated that the application zone 131 may be positioned in other places within the system 100. For example, the process of applying a dopant material can be completed after forming the precursor shaped abrasive particles 123, and more particularly, after the post-forming zone 125. In yet other instances, which will be described in more detail herein, the process of applying a dopant material may be conducted simultaneously with a process of forming the precursor shaped abrasive particles 123.

Within the application zone 131, a dopant material may be applied utilizing various methods including for example, spraying, dipping, depositing, impregnating, transferring, punching, cutting, pressing, crushing, and any combination thereof. In particular instances, the application zone 131 may utilize a spray nozzle, or a combination of spray nozzles 132 and 133 to spray dopant material onto the precursor shaped abrasive particles 123.

In accordance with an embodiment, applying a dopant material can include the application of a particular material, such as a precursor. In certain instances, the precursor can be a salt, such as a metal salt, that includes a dopant material to be incorporated into the finally-formed shaped abrasive particles. For example, the metal salt can include an element or compound that is the precursor to the dopant material. It will be appreciated that the salt material may be in liquid form, such as in a dispersion comprising the salt and liquid carrier. The salt may include nitrogen, and more particularly, can include a nitrate. In other embodiments, the salt can be a chloride, sulfate, phosphate, and a combination thereof. In one embodiment, the salt can include a metal nitrate, and more particularly, consist essentially of a metal nitrate.

In one embodiment, the dopant material can include an element or compound such as an alkali element, alkaline earth element, rare earth element, hafnium, zirconium, niobium, tantalum, molybdenum, vanadium, or a combination thereof. In one particular embodiment, the dopant material includes an element or compound including an element such as lithium, sodium, potassium, magnesium, calcium, strontium, barium, scandium, yttrium, lanthanum, cesium, praseodymium, niobium, hafnium, zirconium, tantalum, molybdenum, vanadium, chromium, cobalt, iron, germanium, manganese, nickel, titanium, zinc, and a combination thereof.

In particular instances, the process of applying a dopant material can include selective placement of the dopant material on at least one exterior surface of a precursor shaped abrasive particle 123. For example, the process of applying a dopant material can include the application of a dopant material to an upper surface or a bottom surface of the precursor shaped abrasive particles 123. In still another embodiment, one or more side surfaces of the precursor shaped abrasive particles 123 can be treated such that a dopant material is applied thereto. It will be appreciated that various methods may be used to apply the dopant material to various exterior surfaces of the precursor shaped abrasive particles 123. For example, a spraying process may be used to apply a dopant material to an upper surface or side surface of the precursor shaped abrasive particles 123. Still, in an alternative embodiment, a dopant material may be applied to the bottom surface of the precursor shaped abrasive particles 123 through a process such as dipping, depositing, impregnating, or a combination thereof. It will be appreciated that a surface of the belt 109 may be treated with dopant material to facilitate a transfer of the dopant material to a bottom surface of precursor shaped abrasive particles 123.

After forming precursor shaped abrasive particles 123, the particles may be translated through a post-forming zone 125. Various processes may be conducted in the post-forming zone 125, including treatment of the precursor shaped abrasive particles 123. In one embodiment, the post-forming zone 125 can include a heating process where the precursor shaped abrasive particles 123 may be dried. Drying may include removal of a particular content of material, including volatiles, such as water. In accordance with an embodiment, the drying process can be conducted at a drying temperature of not greater than about 300° C., such as not greater than about 280° C., or even not greater than about 250° C. Still, in one non-limiting embodiment, the drying process may be conducted at a drying temperature of at least about 50° C. It will be appreciated that the drying temperature may be within a range between any of the minimum and maximum temperatures noted above. Furthermore, the precursor shaped abrasive particles 123 may be translated through the post-forming zone 125 at a particular rate, such as at least about 0.2 feet/min and not greater than about 8 feet/min.

Furthermore, the drying process may be conducted for a particular duration. For example, the drying process may be not greater than about six hours.

After the precursor shaped abrasive particles 123 are translated through the post-forming zone 125, the precursor shaped abrasive particles 123 may be removed from the belt 109. The precursor shaped abrasive particles 123 may be collected in a bin 127 for further processing.

In accordance with an embodiment, the process of forming shaped abrasive particles may further comprise a sintering process. For certain processes of embodiments herein, sintering can be conducted after collecting the precursor shaped abrasive particles 123 from the belt 109. Alternatively, the sintering may be a process that is conducted while the precursor shaped abrasive particles 123 are on the belt 109. Sintering of the precursor shaped abrasive particles 123 may be utilized to densify the particles, which are generally in a green state. In a particular instance, the sintering process can facilitate the formation of a high-temperature phase of the ceramic material. For example, in one embodiment, the precursor shaped abrasive particles 123 may be sintered such that a high-temperature phase of alumina, such as alpha alumina, is formed. In one instance, a shaped abrasive particle can comprise at least about 90 wt % alpha alumina for the total weight of the particle. In other instances, the content of alpha alumina may be greater such that the shaped abrasive particle may consist essentially of alpha alumina.

Additionally, the body of the finally-formed shaped abrasive particles can have particular two-dimensional shapes. For example, the body can have a two-dimensional shape, as viewed in a plane defined by the length and width of the body, and can have a shape including a polygonal shape, ellipsoidal shape, a numeral, a Greek alphabet character, a Latin alphabet character, a Russian alphabet character, a complex shape utilizing a combination of polygonal shapes and a combination thereof. Particular polygonal shapes include triangular, rectangular, trapezoidal, pentagonal, hexagonal, heptagonal, octagonal, nonagonal, decagonal, and any combination thereof. In another embodiment, the body can include a two-dimensional shape, as viewed in a plane defined by a length and a width of the body, including shapes selected from the group consisting of ellipsoids, Greek alphabet characters, Latin alphabet characters, Russian alphabet characters, and a combination thereof.

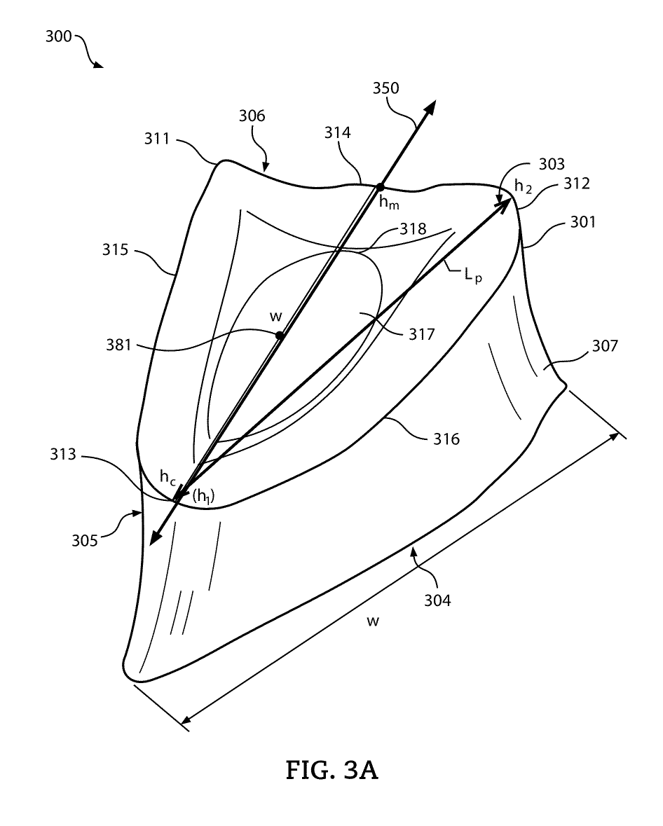

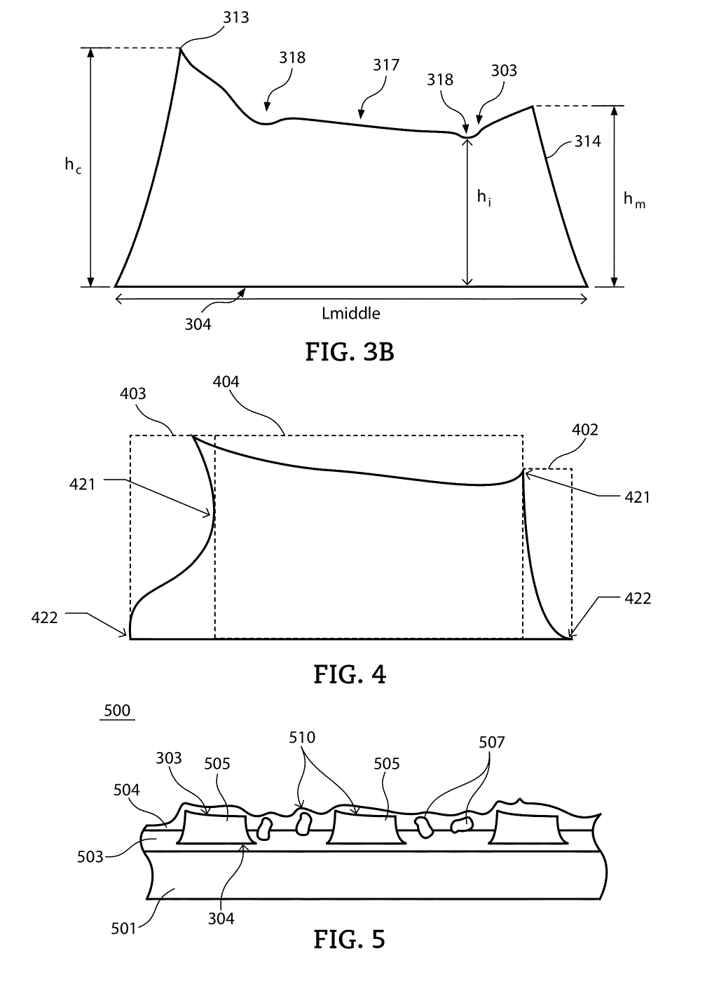

FIG. 3A includes a perspective view illustration of a shaped abrasive particle 300 in accordance with an embodiment. Additionally, FIG. 3B includes a cross-sectional illustration of the abrasive particle of FIG. 3A. A body 301 of the shaped abrasive particle 300 includes an upper major surface 303 (i.e., a first major surface) and a bottom major surface 304 (i.e., a second major surface) opposite the upper major surface 303. The upper surface 303 and the bottom surface 304 can be separated from each other by side surfaces 305, 306, and 307. As illustrated, the body 301 of the shaped abrasive particle 300 can have a generally triangular shape as viewed in a plane of the upper surface 303. In particular, the body 301 can have a length (Lmiddle) as shown in FIG. 3B, which may be measured at the bottom surface 304 of the body 301 as extending from a corner 313 through a midpoint 381 of the body 301 to a midpoint at the opposite edge 314 of the body. Alternatively, the body 301 can be defined by a second length or profile length (Lp), which is the measure of the dimension of the body 301 from a side view at the upper surface 303 from a first corner 313 to an adjacent corner 312. Notably, the dimension of Lmiddle can be a length defining a distance between a height at a corner (hc) and a height at a midpoint edge (hm) opposite the corner. The dimension Lp can be a profile length along a side of the particle 300 (as seen from a side view such as shown in FIGS. 2A and 2B) defining the distance between h1 and h2. Reference herein to the length can refer to either Lmiddle or Lp.

The body 301 can further include a width (w) that is the longest dimension of the body 301 and extending along a side. The body 301 can further include a height (h), which may be a dimension of the body 301 extending in a direction perpendicular to the length and width in a direction defined by a side surface of the body 301. Notably, as will be described in more detail herein, the body 301 can be defined by various heights depending upon the location on the body 301. In specific instances, the width can be greater than or equal to the length, the length can be greater than or equal to the height, and the width can be greater than or equal to the height.

Moreover, reference herein to any dimensional characteristic (e.g., h1, h2, hi, w, Lmiddle, Lp, and the like) can be reference to a dimension of a single shaped abrasive particle of a batch, a median value, or an average value derived from analysis of a suitable sampling of shaped abrasive particles from a batch. Unless stated explicitly, reference herein to a dimensional characteristic can be considered reference to a median value that is a based on a statistically significant value derived from a sample size of a suitable number of particles from a batch of particles. Notably, for certain embodiments herein, the sample size can include at least 10 randomly selected particles from a batch of particles. A batch of particles may be a group of particles that are collected from a single process run. Additionally or alternatively, a batch of particles may include an amount of shaped abrasive particles suitable for forming a commercial grade abrasive product, such as at least about 20 lbs. of particles.

In accordance with an embodiment, the body 301 of the shaped abrasive particle can have a first corner height (hc) at a first region of the body defined by a corner 313. Notably, the corner 313 may represent the point of greatest height on the body 301, however, the height at the corner 313 does not necessarily represent the point of greatest height on the body 301. The corner 313 can be defined as a point or region on the body 301 defined by the joining of the upper surface 303, and two side surfaces 305 and 307. The body 301 may further include other corners, spaced apart from each other, including for example, corner 311 and corner 312. As further illustrated, the body 301 can include edges 314, 315, and 316 that can be separated from each other by the corners 311, 312, and 313. The edge 314 can be defined by an intersection of the upper surface 303 with the side surface 306. The edge 315 can be defined by an intersection of the upper surface 303 and side surface 305 between corners 311 and 313. The edge 316 can be defined by an intersection of the upper surface 303 and side surface 307 between corners 312 and 313.

As further illustrated, the body 301 can include a second midpoint height (hm) at a second end of the body 301, which can be defined by a region at the midpoint of the edge 314, which can be opposite the first end defined by the corner 313. The axis 350 can extend between the two ends of the body 301. FIG. 3B is a cross-sectional illustration of the body 301 along the axis 350, which can extend through a midpoint 381 of the body 301 along the dimension of length (Lmiddle) between the corner 313 and the midpoint of the edge 314.

In accordance with an embodiment, the shaped abrasive particles of the embodiments herein, including for example, the particle of FIGS. 3A and 3B can have an average difference in height, which is a measure of the difference between hc and hm. For convention herein, average difference in height will be generally identified as hc−hm, however it is defined as an absolute value of the difference. Therefore, it will be appreciated that average difference in height may be calculated as hm−hc when the height of the body 301 at the midpoint of the edge 314 is greater than the height at the corner 313. More particularly, the average difference in height can be calculated based upon a plurality of shaped abrasive particles from a suitable sample size. The heights hc and hm of the particles can be measured using a STIL (Sciences et Techniques Industrielles de la Lumiere—France) Micro Measure 3D Surface Profilometer (white light (LED) chromatic aberration technique) and the average difference in height can be calculated based on the average values of hc and hm from the sample.

As illustrated in FIG. 3B, in one particular embodiment, the body 301 of the shaped abrasive particle 300 may have an average difference in height at different locations at the body 301. The body 301 can have an average difference in height, which can be the absolute value of [hc−hm] between the first corner height (hc) and the second midpoint height (hm) that is at least about 20 microns. It will be appreciated that average difference in height may be calculated as hm−hc when the height of the body 301 at a midpoint of the edge is greater than the height at an opposite corner. In other instances, the average difference in height [hc−hm] can be at least about 25 microns, at least about 30 microns, at least about 36 microns, at least about 40 microns, at least about 60 microns, such as at least about 65 microns, at least about 70 microns, at least about 75 microns, at least about 80 microns, at least about 90 microns, or even at least about 100 microns. In one non-limiting embodiment, the average difference in height can be not greater than about 300 microns, such as not greater than about 250 microns, not greater than about 220 microns, or even not greater than about 180 microns. It will be appreciated that the average difference in height can be within a range between any of the minimum and maximum values noted above. Moreover, it will be appreciated that the average difference in height can be based upon an average value of hc. For example, the average height of the body 301 at the corners (Ahc) can be calculated by measuring the height of the body 301 at all corners and averaging the values, and may be distinct from a single value of height at one corner (hc). Accordingly, the average difference in height may be given by the absolute value of the equation [Ahc−hi]. Furthermore, it will be appreciated that the average difference in height can be calculated using a median interior height (Mhi) calculated from a suitable sample size from a batch of shaped abrasive particles and an average height at the corners for all particles in the sample size. Accordingly, the average difference in height may be given by the absolute value of the equation [Ahc−Mhi].

In particular instances, the body 301 can be formed to have a primary aspect ratio, which is a ratio expressed as width:length, having a value of at least 1:1. In other instances, the body 301 can be formed such that the primary aspect ratio (w:l) is at least about 1.5:1, such as at least about 2:1, at least about 4:1, or even at least about 5:1. Still, in other instances, the abrasive particle 300 can be formed such that the body 301 has a primary aspect ratio that is not greater than about 10:1, such as not greater than 9:1, not greater than about 8:1, or even not greater than about 5:1. It will be appreciated that the body 301 can have a primary aspect ratio within a range between any of the ratios noted above. Furthermore, it will be appreciated that reference herein to a height can be reference to the maximum height measurable of the abrasive particle 300. It will be described later that the abrasive particle 300 may have different heights at different positions within the body 301 of the abrasive particle 300.

In addition to the primary aspect ratio, the abrasive particle 300 can be formed such that the body 301 comprises a secondary aspect ratio, which can be defined as a ratio of length:height, wherein the height is an interior median height (Mhi). In certain instances, the secondary aspect ratio can be at least about 1:1, such as at least about 2:1, at least about 4:1, or even at least about 5:1. Still, in other instances, the abrasive particle 300 can be formed such that the body 301 has a secondary aspect ratio that is not greater than about 1:3, such as not greater than 1:2, or even not greater than about 1:1. It will be appreciated that the body 301 can have a secondary aspect ratio within a range between any of the ratios noted above, such as within a range between about 5:1 and about 1:1.

In accordance with another embodiment, the abrasive particle 300 can be formed such that the body 301 comprises a tertiary aspect ratio, defined by the ratio width:height, wherein the height is an interior median height (Mhi). The tertiary aspect ratio of the body 301 can be can be at least about 1:1, such as at least about 2:1, at least about 4:1, at least about 5:1, or even at least about 6:1. Still, in other instances, the abrasive particle 300 can be formed such that the body 301 has a tertiary aspect ratio that is not greater than about 3:1, such as not greater than 2:1, or even not greater than about 1:1. It will be appreciated that the body 301 can have a tertiary aspect ratio within a range between any of the ratios noted above, such as within a range between about 6:1 and about 1:1.

According to one embodiment, the body 301 of the shaped abrasive particle 300 can have particular dimensions, which may facilitate improved performance. For example, in one instance, the body 301 can have an interior height (hi), which can be the smallest dimension of height of the body 301 as measured along a dimension between any corner and opposite midpoint edge on the body 301. In particular instances, wherein the body 301 is a generally triangular two-dimensional shape, the interior height (hi) may be the smallest dimension of height (i.e., measure between the bottom surface 304 and the upper surface 305) of the body 301 for three measurements taken between each of the three corners and the opposite midpoint edges. The interior height (hi) of the body 301 of a shaped abrasive particle 300 is illustrated in FIG. 3B. According to one embodiment, the interior height (hi) can be at least about 20% of the width (w). The height (hi) may be measured by sectioning or mounting and grinding the shaped abrasive particle 300 and viewing in a manner sufficient (e.g., light microscope or SEM) to determine the smallest height (hi) within the interior of the body 301. In one particular embodiment, the height (hi) can be at least about 22% of the width, such as at least about 25%, at least about 30%, or even at least about 33%, of the width of the body 301. For one non-limiting embodiment, the height (hi) of the body 301 can be not greater than about 80% of the width of the body 301, such as not greater than about 76%, not greater than about 73%, not greater than about 70%, not greater than about 68% of the width, not greater than about 56% of the width, not greater than about 48% of the width, or even not greater than about 40% of the width. It will be appreciated that the height (hi) of the body 301 can be within a range between any of the above noted minimum and maximum percentages.

A batch of shaped abrasive particles, can be fabricated, wherein the median interior height value (Mhi) can be controlled, which may facilitate improved performance. In particular, the median internal height (hi) of a batch can be related to a median width of the shaped abrasive particles of the batch in the same manner as described above. Notably, the median interior height (Mhi) can be at least about 20% of the width, such as at least about 22%, at least about 25%, at least about 30%, or even at least about 33% of the median width of the shaped abrasive particles of the batch. For one non-limiting embodiment, the median interior height (Mhi) of the body 301 can be not greater than about 80%, such as not greater than about 76%, not greater than about 73%, not greater than about 70%, not greater than about 68% of the width, not greater than about 56% of the width, not greater than about 48% of the width, or even not greater than about 40% of the median width of the body 301. It will be appreciated that the median interior height (Mhi) of the body 301 can be within a range between any of the above noted minimum and maximum percentages.

Furthermore, the batch of shaped abrasive particles may exhibit improved dimensional uniformity as measured by the standard deviation of a dimensional characteristic from a suitable sample size. According to one embodiment, the shaped abrasive particles can have an interior height variation (Vhi), which can be calculated as the standard deviation of interior height (hi) for a suitable sample size of particles from a batch. According to one embodiment, the interior height variation can be not greater than about 60 microns, such as not greater than about 58 microns, not greater than about 56 microns, or even not greater than about 54 microns. In one non-limiting embodiment, the interior height variation (Vhi) can be at least about 2 microns. It will be appreciated that the interior height variation of the body can be within a range between any of the above noted minimum and maximum values.

For another embodiment, the body 301 of the shaped abrasive particle 300 can have an interior height (hi) of at least about 400 microns. More particularly, the height may be at least about 450 microns, such as at least about 475 microns, or even at least about 500 microns. In still one non-limiting embodiment, the height of the body 301 can be not greater than about 3 mm, such as not greater than about 2 mm, not greater than about 1.5 mm, not greater than about 1 mm, or even not greater than about 800 microns. It will be appreciated that the height of the body 301 can be within a range between any of the above noted minimum and maximum values. Moreover, it will be appreciated that the above range of values can be representative of a median interior height (Mhi) value for a batch of shaped abrasive particles.

For certain embodiments herein, the body 301 of the shaped abrasive particle 300 can have particular dimensions, including for example, a width>length, a length>height, and a width>height. More particularly, the body 301 of the shaped abrasive particle 300 can have a width (w) of at least about 600 microns, such as at least about 700 microns, at least about 800 microns, or even at least about 900 microns. In one non-limiting instance, the body 301 can have a width of not greater than about 4 mm, such as not greater than about 3 mm, not greater than about 2.5 mm, or even not greater than about 2 mm. It will be appreciated that the width of the body 301 can be within a range between any of the above noted minimum and maximum values. Moreover, it will be appreciated that the above range of values can be representative of a median width (Mw) for a batch of shaped abrasive particles.

The body 301 of the shaped abrasive particle 300 can have particular dimensions, including for example, a length (L middle or Lp) of at least about 0.4 mm, such as at least about 0.6 mm, at least about 0.8 mm, or even at least about 0.9 mm. Still, for at least one non-limiting embodiment, the body 301 can have a length of not greater than about 4 mm, such as not greater than about 3 mm, not greater than about 2.5 mm, or even not greater than about 2 mm. It will be appreciated that the length of the body 301 can be within a range between any of the above noted minimum and maximum values. Moreover, it will be appreciated that the above range of values can be representative of a median length (Ml), which may be more particularly, a median middle length (MLmiddle) or median profile length (MLp) for a batch of shaped abrasive particles.

The shaped abrasive particle 300 can have a body 301 having a particular amount of dishing, wherein the dishing value (d) can be defined as a ratio between an average height of the body 301 at the corners (Ahc) as compared to smallest dimension of height of the body 301 at the interior (hi). The average height of the body 301 at the corners (Ahc) can be calculated by measuring the height of the body 301 at all corners and averaging the values, and may be distinct from a single value of height at one corner (hc). The average height of the body 301 at the corners or at the interior can be measured using a STIL (Sciences et Techniques Industrielles de la Lumiere—France) Micro Measure 3D Surface Profilometer (white light (LED) chromatic aberration technique). Alternatively, the dishing may be based upon a median height of the particles at the corner (Mhc) calculated from a suitable sampling of particles from a batch. Likewise, the interior height (hi) can be a median interior height (Mhi) derived from a suitable sampling of shaped abrasive particles from a batch. According to one embodiment, the dishing value (d) can be not greater than about 2, such as not greater than about 1.9, not greater than about 1.8, not greater than about 1.7, not greater than about 1.6, not greater than about 1.5, or even not greater than about 1.2. Still, in at least one non-limiting embodiment, the dishing value (d) can be at least about 0.9, such as at least about 1.0. It will be appreciated that the dishing ratio can be within a range between any of the minimum and maximum values noted above. Moreover, it will be appreciated that the above dishing values can be representative of a median dishing value (Md) for a batch of shaped abrasive particles.

The shaped abrasive particles of the embodiments herein, including for example, the body 301 of the particle of FIG. 3A can have a bottom surface 304 defining a bottom area (A_{b}). In particular instances, the bottom surface 304 can be the largest surface of the body 301. The bottom major surface 304 can have a surface area defined as the bottom area (A_{b}) that is different than the surface area of the upper major surface 303. In one particular embodiment, the bottom major surface 304 can have a surface area defined as the bottom area (A_{b}) that is different than the surface area of the upper major surface 303. In another embodiment, the bottom major surface 304 can have a surface area defined as the bottom area (A_{b}) that is less than the surface area of the upper major surface 303.

Additionally, the body 301 can have a cross-sectional midpoint area (Aₘ) defining an area of a plane perpendicular to the bottom area (A_{b}) and extending through a midpoint 381 of the particle 300. In certain instances, the body 301 can have an area ratio of bottom area to midpoint area (A_{b}/Aₘ) of not greater than about 6. In more particular instances, the area ratio can be not greater than about 5.5, such as not greater than about 5, not greater than about 4.5, not greater than about 4, not greater than about 3.5, or even not greater than about 3. Still, in one non-limiting embodiment, the area ratio may be at least about 1.1, such as at least about 1.3, or even at least about 1.8. It will be appreciated that the area ratio can be within a range between any of the minimum and maximum values noted above. Moreover, it will be appreciated that the above area ratios can be representative of a median area ratio for a batch of shaped abrasive particles.

Furthermore the shaped abrasive particles of the embodiments herein including, for example, the particle of FIG. 3B, can have a normalized height difference of not greater than about 0.3. The normalized height difference can be defined by the absolute value of the equation [(hc−hm)/(hi)]. In other embodiments, the normalized height difference can be not greater than about 0.26, such as not greater than about 0.22, or even not greater than about 0.19. Still, in one particular embodiment, the normalized height difference can be at least about 0.04, such as at least about 0.05, or even at least about 0.06. It will be appreciated that the normalized height difference can be within a range between any of the minimum and maximum values noted above. Moreover, it will be appreciated that the above normalized height values can be representative of a median normalized height value for a batch of shaped abrasive particles.

In another instance, the body 301 can have a profile ratio of at least about 0.04, wherein the profile ratio is defined as a ratio of the average difference in height [hc−hm] to the length (Lmiddle) of the shaped abrasive particle 300, defined as the absolute value of [(hc−hm)/(Lmiddle)]. It will be appreciated that the length (Lmiddle) of the body 301 can be the distance across the body 301 as illustrated in FIG. 3B. Moreover, the length may be an average or median length calculated from a suitable sampling of particles from a batch of shaped abrasive particles as defined herein. According to a particular embodiment, the profile ratio can be at least about 0.05, at least about 0.06, at least about 0.07, at least about 0.08, or even at least about 0.09. Still, in one non-limiting embodiment, the profile ratio can be not greater than about 0.3, such as not greater than about 0.2, not greater than about 0.18, not greater than about 0.16, or even not greater than about 0.14. It will be appreciated that the profile ratio can be within a range between any of the minimum and maximum values noted above. Moreover, it will be appreciated that the above profile ratio can be representative of a median profile ratio for a batch of shaped abrasive particles.

According to another embodiment, the body 301 can have a particular rake angle, which may be defined as an angle between the bottom surface 304 and a side surface 305, 306 or 307 of the body 301. For example, the rake angle may be within a range between about 1° and about 80°. For other particles herein, the rake angle can be within a range between about 5° and 55°, such as between about 10° and about 50°, between about 15° and 50°, or even between about 20° and 50°. Formation of an abrasive particle having such a rake angle can improve the abrading capabilities of the abrasive particle 300. Notably, the rake angle can be within a range between any two rake angles noted above.

According to another embodiment, the shaped abrasive particles herein including, for example, the particles of FIGS. 3A and 3B, can have an ellipsoidal region 317 in the upper surface 303 of the body 301. The ellipsoidal region 317 can be defined by a trench region 318 that can extend around the upper surface 303 and define the ellipsoidal region 317. The ellipsoidal region 317 can encompass the midpoint 381. Moreover, it is thought that the ellipsoidal region 317 defined in the upper surface 303 can be an artifact of the forming process, and may be formed as a result of the stresses imposed on the mixture 101 during formation of the shaped abrasive particles according to the methods described herein.

The shaped abrasive particle 300 can be formed such that the body 301 includes a crystalline material, and more particularly, a polycrystalline material. Notably, the polycrystalline material can include abrasive grains. In one embodiment, the body 301 can be essentially free of an organic material, including for example, a binder. More particularly, the body 301 can consist essentially of a polycrystalline material.

In one aspect, the body 301 of the shaped abrasive particle 300 can be an agglomerate including a plurality of abrasive particles, grit, and/or grains bonded to each other to form the body 301 of the abrasive particle 300. Suitable abrasive grains can include nitrides, oxides, carbides, borides, oxynitrides, oxyborides, diamond, and a combination thereof. In particular instances, the abrasive grains can include an oxide compound or complex, such as aluminum oxide, zirconium oxide, titanium oxide, yttrium oxide, chromium oxide, strontium oxide, silicon oxide, and a combination thereof. In one particular instance, the abrasive particle 300 is formed such that the abrasive grains forming the body 301 include alumina, and more particularly, may consist essentially of alumina. Moreover, in particular instances, the shaped abrasive particle 300 can be formed from a seeded sol-gel.

The abrasive grains (i.e., crystallites) contained within the body 301 may have an average grain size that is generally not greater than about 100 microns. In other embodiments, the average grain size can be less, such as not greater than about 80 microns, not greater than about 50 microns, not greater than about 30 microns, not greater than about 20 microns, not greater than about 10 microns, or even not greater than about 1 micron. Still, the average grain size of the abrasive grains contained within the body 301 can be at least about 0.01 microns, such as at least about 0.05 microns, such as at least about 0.08 microns, at least about 0.1 microns, or even at least about 0.5 microns. It will be appreciated that the abrasive grains can have an average grain size within a range between any of the minimum and maximum values noted above.

In accordance with certain embodiments, the abrasive particle 300 can be a composite article including at least two different types of abrasive grains within the body 301. It will be appreciated that different types of abrasive grains are abrasive grains having different compositions with regard to each other. For example, the body 301 can be formed such that is includes at least two different types of abrasive grains, wherein the two different types of abrasive grains can be nitrides, oxides, carbides, borides, oxynitrides, oxyborides, diamond, and a combination thereof.

In accordance with an embodiment, the abrasive particle 300 can have an average particle size, as measured by the largest dimension measurable on the body 301, of at least about 100 microns. In fact, the abrasive particle 300 can have an average particle size of at least about 150 microns, such as at least about 200 microns, at least about 300 microns, at least about 400 microns, at least about 500 microns, at least about 600 microns, at least about 700 microns, at least about 800 microns, or even at least about 900 microns. Still, the abrasive particle 300 can have an average particle size that is not greater than about 5 mm, such as not greater than about 3 mm, not greater than about 2 mm, or even not greater than about 1.5 mm. It will be appreciated that the abrasive particle 300 can have an average particle size within a range between any of the minimum and maximum values noted above.

The shaped abrasive particles of the embodiments herein can have a percent flashing that may facilitate improved performance. Notably, the flashing defines an area of the particle as viewed along one side, such as illustrated in FIG. 4, wherein the flashing extends from a side surface of the body 301 within the boxes 402 and 403. The flashing can represent tapered regions proximate to the upper surface 303 and bottom surface 304 of the body 301. The flashing can be measured as the percentage of area of the body 301 along the side surface contained within a box extending between an innermost point of the side surface (e.g., 421) and an outermost point (e.g., 422) on the side surface of the body 301. In one particular instance, the body 301 can have a particular content of flashing, which can be the percentage of area of the body 301 contained within the boxes 402 and 403 compared to the total area of the body 301 contained within boxes 402, 403, and 404. According to one embodiment, the percent flashing (f) of the body 301 can be at least about 1%. In another embodiment, the percent flashing can be greater, such as at least about 2%, at least about 3%, at least about 5%, at least about 8%, at least about 10%, at least about 12%, such as at least about 15%, at least about 18%, or even at least about 20%. Still, in a non-limiting embodiment, the percent flashing of the body 301 can be controlled and may be not greater than about 45%, such as not greater than about 40%, not greater than about 35%, not greater than about 30%, not greater than about 25%, not greater than about 20%, not greater than about 18%, not greater than about 15%, not greater than about 12%, not greater than about 10%, not greater than about 8%, not greater than about 6%, or even not greater than about 4%. It will be appreciated that the percent flashing of the body 301 can be within a range between any of the above minimum and maximum percentages. Moreover, it will be appreciated that the above flashing percentages can be representative of an average flashing percentage or a median flashing percentage for a batch of shaped abrasive particles.

The percent flashing can be measured by mounting the shaped abrasive particle 300 on its side and viewing the body 301 at the side to generate a black and white image, such as illustrated in FIG. 4. A suitable program for such includes ImageJ software. The percentage flashing can be calculated by determining the area of the body 301 in the boxes 402 and 403 compared to the total area of the body 301 as viewed at the side (total shaded area), including the area in the center 404 and within the boxes. Such a procedure can be completed for a suitable sampling of particles to generate average, median, and/or and standard deviation values.

A batch of shaped abrasive particles according to embodiments herein may exhibit improved dimensional uniformity as measured by the standard deviation of a dimensional characteristic from a suitable sample size. According to one embodiment, the shaped abrasive particles can have a flashing variation (Vf), which can be calculated as the standard deviation of flashing percentage (f) for a suitable sample size of particles from a batch. According to one embodiment, the flashing variation can be not greater than about 5.5%, such as not greater than about 5.3%, not greater than about 5%, or not greater than about 4.8%, not greater than about 4.6%, or even not greater than about 4.4%. In one non-limiting embodiment, the flashing variation (Vf) can be at least about 0.1%. It will be appreciated that the flashing variation can be within a range between any of the minimum and maximum percentages noted above.

The shaped abrasive particles of the embodiments herein can have a height (hi) and flashing multiplier value (hiF) of at least 4000, wherein hiF=(hi)(f), an “hi” represents a minimum interior height of the body 301 as described above and “f” represents the percent flashing. In one particular instance, the height and flashing multiplier value (hiF) of the body 301 can be greater, such as at least about 4500 micron %, at least about 5000 micron %, at least about 6000 micron %, at least about 7000 micron %, or even at least about 8000 micron %. Still, in one non-limiting embodiment, the height and flashing multiplier value can be not greater than about 45000 micron %, such as not greater than about 30000 micron %, not greater than about 25000 micron %, not greater than about 20000 micron %, or even not greater than about 18000 micron %. It will be appreciated that the height and flashing multiplier value of the body 301 can be within a range between any of the above minimum and maximum values. Moreover, it will be appreciated that the above multiplier value can be representative of a median multiplier value (MhiF) for a batch of shaped abrasive particles.

Coated Abrasive Article

After forming or sourcing the shaped abrasive particle 300, the particles may be combined with a backing to form a coated abrasive article. In particular, the coated abrasive article may utilize a plurality of shaped abrasive particles, which can be dispersed in a single layer and overlying the backing.

As illustrated in FIG. 5, the coated abrasive 500 can include a substrate 501 (i.e., a backing) and at least one adhesive layer overlying a surface of the substrate 501. The adhesive layer can include a make coat 503 and/or a size coat 504. The coated abrasive 500 can include abrasive particulate material 510, which can include shaped abrasive particles 505 of the embodiments herein and a second type of abrasive particulate material 507 in the form of diluent abrasive particles having a random shape, which may not necessarily be shaped abrasive particles. The make coat 503 can be overlying the surface of the substrate 501 and surrounding at least a portion of the shaped abrasive particles 505 and second type of abrasive particulate material 507. The size coat 504 can be overlying and bonded to the shaped abrasive particles 505 and second type of abrasive particulate material 507 and the make coat 503.

According to one embodiment, the substrate 501 can include an organic material, inorganic material, and a combination thereof. In certain instances, the substrate 501 can include a woven material. However, the substrate 501 may be made of a non-woven material. Particularly suitable substrate materials can include organic materials, including polymers, and particularly, polyester, polyurethane, polypropylene, polyimides such as KAPTON from DuPont, paper. Some suitable inorganic materials can include metals, metal alloys, and particularly, foils of copper, aluminum, steel, and a combination thereof.

A polymer formulation may be used to form any of a variety of layers of the abrasive article such as, for example, a frontfill, a pre-size, the make coat, the size coat, and/or a supersize coat. When used to form the frontfill, the polymer formulation generally includes a polymer resin, fibrillated fibers (preferably in the form of pulp), filler material, and other optional additives. Suitable formulations for some frontfill embodiments can include material such as a phenolic resin, wollastonite filler, defoamer, surfactant, a fibrillated fiber, and a balance of water. Suitable polymeric resin materials include curable resins selected from thermally curable resins including phenolic resins, urea/formaldehyde resins, phenolic/latex resins, as well as combinations of such resins. Other suitable polymeric resin materials may also include radiation curable resins, such as those resins curable using electron beam, UV radiation, or visible light, such as epoxy resins, acrylated oligomers of acrylated epoxy resins, polyester resins, acrylated urethanes and polyester acrylates and acrylated monomers including monoacrylated, multiacrylated monomers. The formulation can also comprise a nonreactive thermoplastic resin binder which can enhance the self-sharpening characteristics of the deposited abrasive composites by enhancing the erodability. Examples of such thermoplastic resin include polypropylene glycol, polyethylene glycol, and polyoxypropylene-polyoxyethene block copolymer, etc. Use of a frontfill on the substrate 501 can improve the uniformity of the surface, for suitable application of the make coat 503 and improved application and orientation of shaped abrasive particles 505 in a predetermined orientation.

The make coat 503 can be applied to the surface of the substrate 501 in a single process, or alternatively, the abrasive particulate material 510 can be combined with a make coat 503 material and applied as a mixture to the surface of the substrate 501. Suitable materials of the make coat 503 can include organic materials, particularly polymeric materials, including for example, polyesters, epoxy resins, polyurethanes, polyamides, polyacrylates, polymethacrylates, polyvinyl chlorides, polyethylene, polysiloxane, silicones, cellulose acetates, nitrocellulose, natural rubber, starch, shellac, and mixtures thereof. In one embodiment, the make coat 503 can include a polyester resin. The coated substrate can then be heated in order to cure the resin and the abrasive particulate material to the substrate. In general, the coated substrate 501 can be heated to a temperature of between about 100° C. to less than about 250° C. during this curing process.

The abrasive particulate material 510 can include shaped abrasive particles 505 according to embodiments herein. In particular instances, the abrasive particulate material 510 may include different types of shaped abrasive particles 505. The different types of shaped abrasive particles can differ from each other in composition, in two-dimensional shape, in three-dimensional shape, in size, and a combination thereof as described in the embodiments herein. As illustrated, the coated abrasive 500 can include a shaped abrasive particle 505 having a generally triangular two-dimensional shape.

The other type of abrasive particles 507 can be diluent particles different than the shaped abrasive particles 505. For example, the diluent particles can differ from the shaped abrasive particles 505 in composition, in two-dimensional shape, in three-dimensional shape, in size, and a combination thereof. For example, the abrasive particles 507 can represent conventional, crushed abrasive grit having random shapes. The abrasive particles 507 may have a median particle size less than the median particle size of the shaped abrasive particles 505.

After sufficiently forming the make coat 503 with the abrasive particulate material 510, the size coat 504 can be formed to overlie and bond the abrasive particulate material 510 in place. The size coat 504 can include an organic material, may be made essentially of a polymeric material, and notably, can use polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof.

According to one embodiment, the shaped abrasive particles 505 herein can be oriented in a predetermined orientation relative to each other and the substrate 501. While not completely understood, it is thought that one or a combination of dimensional features are responsible for the improved positioning of the shaped abrasive particles 505. According to one embodiment, the shaped abrasive particles 505 can be oriented in a flat orientation relative to the substrate 501, such as that shown in FIG. 5. In the flat orientation, the bottom surface 304 of the shaped abrasive particles can be closest to a surface of the substrate 501 (i.e., the backing) and the upper surface 303 of the shaped abrasive particles 505 can be directed away from the substrate 501 and configured to conduct initial engagement with a workpiece.

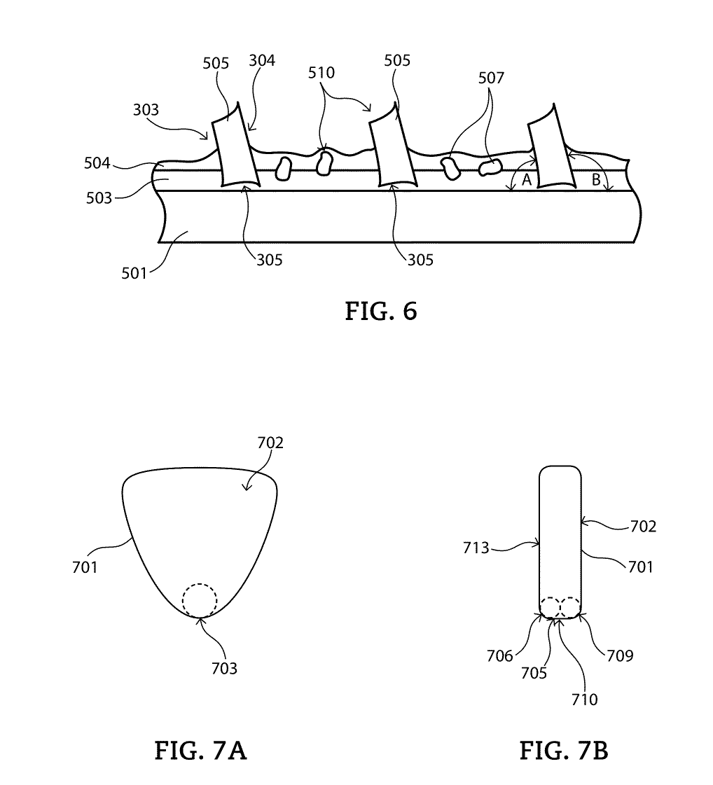

According to another embodiment, the shaped abrasive particles 505 can be placed on a substrate 501 in a predetermined side orientation, such as that shown in FIG. 6. In particular instances, a majority of the shaped abrasive particles 505 of the total content of shaped abrasive particles 505 on the abrasive article 500 can have a predetermined and side orientation. In the side orientation, the bottom surface 304 of the shaped abrasive particles 505 can be spaced away and angled relative to the surface of the substrate 501. In particular instances, the bottom surface 304 can form an obtuse angle (A) relative to the surface of the substrate 501. Moreover, the upper surface 303 is spaced away and angled relative to the surface of the substrate 501, which in particular instances, may define a generally acute angle (B). In a side orientation, a side surface (305, 306, or 307) can be closest to the surface of the substrate 501, and more particularly, may be in direct contact with a surface of the substrate 501.

For certain other abrasive articles herein, at least about 55% of the plurality of shaped abrasive particles 505 on the abrasive article 500 can have a predetermined side orientation. Still, the percentage may be greater, such as at least about 60%, at least about 65%, at least about 70%, at least about 75%, at least about 77%, at least about 80%, at least about 81%, or even at least about 82%. And for one non-limiting embodiment, an abrasive article 500 may be formed using the shaped abrasive particles 505 herein, wherein not greater than about 99% of the total content of shaped abrasive particles have a predetermined side orientation.

To determine the percentage of particles in a predetermined orientation, a 2D microfocus x-ray image of the abrasive article 500 is obtained using a CT scan machine run in the conditions of Table 1 below. The X-ray 2D imaging was conducted on RB214 with Quality Assurance software. A specimen mounting fixture utilizes a plastic frame with a 4″×4″ window and an Ø0.5″ solid metallic rod, the top part of which is half flattened with two screws to fix the frame. Prior to imaging, a specimen was clipped over one side of the frame where the screw heads were faced with the incidence direction of the X-rays. Then five regions within the 4″×4″ window area are selected for imaging at 120 kV/80 μA. Each 2D projection was recorded with the X-ray off-set/gain corrections and at a magnification of 15 times.

TABLE 1

| | | | Field of view | |
|---|---|---|---|---|
| Voltage | Current | | per image | |
| (kV) | (μA) | Magnification | (mm × mm) | Exposure time |
| 120 | 80 | 15X | 16.2 × 13.0 | 500 ms/2.0 fps |

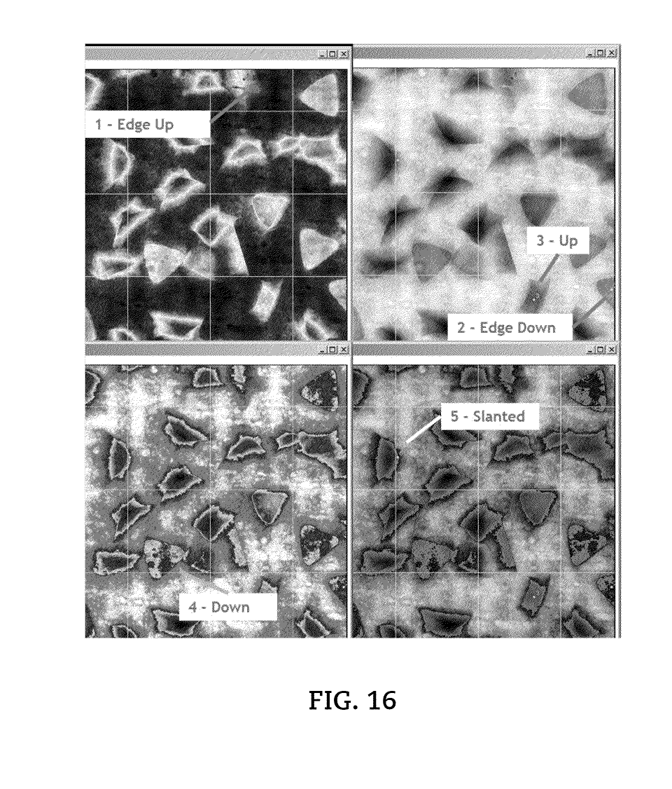

The image is then imported and analyzed using the ImageJ program, wherein different orientations are assigned values according to Table 2 below. FIG. 16 includes images representative of portions of a coated abrasive according to an embodiment and used to analyze the orientation of shaped abrasive particles on the backing.

TABLE 2

| Cell marker | |
|---|---|
| type | Comments |
| 1 | Grains on the perimeter of the image, partially exposed - |
| | standing up |
| 2 | Grains on the perimeter of the image, partially exposed - |
| | down |
| 3 | Grains on the image, completely exposed - standing vertical |
| 4 | Grains on the image, completely exposed - down |
| 5 | Grains on the image, completely exposed - standing slanted |
| | (between standing vertical and down) |

Three calculations are then performed as provided below in Table 3. After conducting the calculations, the percentage of grains in a particular orientation (e.g., side orientation) per square centimeter can be derived.

TABLE 3

| 5) Parameter | Protocol* |
|---|---|
| % grains up | ((0.5 × 1) + 3 + 5)/ |
| | (1 + 2 + 3 + 4 + 5) |
| Total # of grains per cm² | (1 + 2 + 3 + 4 + 5) |
| # of grains up per cm² | (% grains up × Total # of grains per cm² |

*These are all normalized with respect to the representative area of the image.
+ - A scale factor of 0.5 was applied to account for the fact that they are not completely present in the image.

Furthermore, the abrasive articles made with the shaped abrasive particles can utilize various contents of the shaped abrasive particles. For example, the abrasive articles can be coated abrasive articles including a single layer of the shaped abrasive particles in an open-coat configuration or a closed-coat configuration. For example, the plurality of shaped abrasive particles can define an open-coat abrasive product having a coating density of shaped abrasive particles of not greater than about 70 particles/cm². In other instances, the density of shaped abrasive particle per square centimeter of the open-coat abrasive article may be not greater than about 65 particles/cm², such as not greater than about 60 particles/cm², not greater than about 55 particles/cm², or even not greater than about 50 particles/cm². Still, in one non-limiting embodiment, the density of the open-coat coated abrasive using the shaped abrasive particle herein can be at least about 5 particles/cm², or even at least about 10 particles/cm². It will be appreciated that the density of shaped abrasive particles per square centimeter of an open-coat coated abrasive article can be within a range between any of the above minimum and maximum values.

In an alternative embodiment, the plurality of shaped abrasive particles can define a closed-coat abrasive product having a coating density of shaped abrasive particles of at least about 75 particles/cm², such as at least about 80 particles/cm², at least about 85 particles/cm², at least about 90 particles/cm², at least about 100 particles/cm². Still, in one non-limiting embodiment, the density of the closed-coat coated abrasive using the shaped abrasive particle herein can be not greater than about 500 particles/cm². It will be appreciated that the density of shaped abrasive particles per square centimeter of the closed-coat abrasive article can be within a range between any of the above minimum and maximum values.

In certain instances, the abrasive article can have an open-coat density of a coating not greater than about 50% of abrasive particle covering the exterior abrasive surface of the article. In other embodiments, the percentage coating of the abrasive particles relative to the total area of the abrasive surface can be not greater than about 40%, not greater than about 30%, not greater than about 25%, or even not greater than about 20%. Still, in one non-limiting embodiment, the percentage coating of the abrasive particles relative to the total area of the abrasive surface can be at least about 5%, such as at least about 10%, at least about 15%, at least about 20%, at least about 25%, at least about 30%, at least about 35%, or even at least about 40%. It will be appreciated that the percent coverage of shaped abrasive particles for the total area of abrasive surface can be within a range between any of the above minimum and maximum values.

Some abrasive articles may have a particular content of abrasive particles for a length (e.g., ream) of the backing or the substrate 501. For example, in one embodiment, the abrasive article may utilize a normalized weight of shaped abrasive particles of at least about 20 lbs/ream, such as at least about 25 lbs/ream, or even at least about 30 lbs/ream. Still, in one non-limiting embodiment, the abrasive articles can include a normalized weight of shaped abrasive particles of not greater than about 60 lbs/ream, such as not greater than about 50 lbs/ream, or even not greater than about 45 lbs/ream. It will be appreciated that the abrasive articles of the embodiments herein can utilize a normalized weight of shaped abrasive particle within a range between any of the above minimum and maximum values.

The plurality of shaped abrasive particles on an abrasive article as described herein can define a first portion of a batch of abrasive particles, and the features described in the embodiments herein can represent features that are present in at least a first portion of a batch of shaped abrasive particles. Moreover, according to an embodiment, control of one or more process parameters as already described herein also can control the prevalence of one or more features of the shaped abrasive particles of the embodiments herein. The provision of one or more features of any shaped abrasive particle of a batch may facilitate alternative or improved deployment of the particles in an abrasive article and may further facilitate improved performance or use of the abrasive article.

The first portion of a batch of abrasive particles may include a plurality of shaped abrasive particles, wherein each of the particles of the plurality of shaped abrasive particles can have substantially the same features, including but not limited to, for example, the same two-dimensional shape of a major surface. Other features include any of the features of the embodiments described herein. The batch may include various contents of the first portion. The first portion may be a minority portion (e.g., less than 50% and any whole number integer between 1% and 49%) of the total number of particles in a batch, a majority portion (e.g., 50% or greater and any whole number integer between 50% and 99%) of the total number of particles of the batch, or even essentially all of the particles of a batch (e.g., between 99% and 100%). For example, the first portion of the batch may be present in a minority amount or majority amount as compared to the total amount of particles in the batch. In particular instances, the first portion may be present in an amount of at least about 1%, such as at least about 5%, at least about 10%, at least about 20%, at least about 30%, at least about 40%, at least about 50%, at least about 60%, or even at least about 70% for the total content of portions within the batch. Still, in another embodiment, the batch may include not greater than about 99%, such as not greater than about 90%, not greater than about 80%, not greater than about 70%, not greater than about 60%, not greater than about 50%, not greater than about 40%, not greater than about 30%, not greater than about 20%, not greater than about 10%, not greater than about 8%, not greater than about 6%, or even not greater than about 4% of the first portion for the total amount of particles within the batch. The batch can include a content of the first portion within a range between any of the minimum and maximum percentages noted above.

The batch may also include a second portion of abrasive particles. The second portion of abrasive particles can include diluent particles. The second portion of the batch can include a plurality of abrasive particles having at least one abrasive characteristic distinct from the plurality of shaped abrasive particles of the first portion, including but not limited to abrasive characteristics such as two-dimensional shape, average particle size, particle color, hardness, friability, toughness, density, specific surface area, aspect ratio, any of the features of the embodiments herein, and a combination thereof.

In certain instances, the second portion of the batch can include a plurality of shaped abrasive particles, wherein each of the shaped abrasive particles of the second portion can have substantially the same feature, including but not limited to, for example, the same two-dimensional shape of a major surface. The second portion can have one or more features of the embodiments herein, and the one or more features of the particles of the second portion can be distinct compared to the plurality of shaped abrasive particles of the first portion. In certain instances, the batch may include a lesser content of the second portion relative to the first portion, and more particularly, may include a minority content of the second portion relative to the total content of particles in the batch. For example, the batch may contain a particular content of the second portion, including for example, not greater than about 40%, such as not greater than about 30%, not greater than about 20%, not greater than about 10%, not greater than about 8%, not greater than about 6%, or even not greater than about 4% for the total content of particles in the batch. Still, in at least one non-limiting embodiment, the batch may contain at least about 0.5%, such as at least about 1%, at least about 2%, at least about 3%, at least about 4%, at least about 10%, at least about 15%, or even at least about 20% of the second portion for the total content of particles within the batch. It will be appreciated that the batch can contain a content of the second portion within a range between any of the minimum and maximum percentages noted above.

Still, in an alternative embodiment, the batch may include a greater content of the second portion relative to the first portion, and more particularly, can include a majority content of the second portion for the total content of particles in the batch. For example, in at least one embodiment, the batch may contain at least about 55%, such as at least about 60%, of the second portion for the total content of particles of the batch.

It will be appreciated that the batch can include additional portions, including for example a third portion, comprising a plurality of shaped abrasive particles having a third feature that can be distinct from the features shared by the particles of either or both of the first and second portions. The batch may include various contents of the third portion relative to the second portion and/or first portion. The third portion may be present in the batch a minority amount or majority amount for the total number of particles of the third portion compared to the total number of particles in the batch. In particular instances, the third portion may be present in an amount of not greater than about 40%, such as not greater than about 30%, not greater than about 20%, not greater than about 10%, not greater than about 8%, not greater than about 6%, or even not greater than about 4% of the total particles within the batch. Still, in other embodiments the batch may include a minimum content of the third portion, such as at least about 1%, such as at least about 5%, at least about 10%, at least about 20%, at least about 30%, at least about 40%, or even at least about 50% of the third portion for the total particles within the batch. The batch can include a content of the third portion within a range between any of the minimum and maximum percentages noted above. Moreover, the batch may include a content of diluent, randomly shaped abrasive particles, which may be present in an amount that is the same as any of the portions of the embodiments herein.

According to another aspect, the first portion of the batch can have a predetermined classification characteristic selected from the group consisting of average particle shape, average particle size, particle color, hardness, friability, toughness, density, specific surface area, major surface corner radius of curvature, side surface corner radius of curvature, a ratio of major surface corner radius of curvature and side surface corner radius of curvature and a combination thereof. Likewise, any of the other portions of the batch may be classified according to the above noted classification characteristics.

FIG. 7A includes a top-view illustration of a major surface of a shaped abrasive particle according to an embodiment. As illustrated, the body 701 of the shaped abrasive particle includes a major surface 702, which can represent the upper major surface or lower major surface of the body 701. As further illustrated, the body 701 can have a generally triangular two-dimensional shape. Moreover, the body 701 can include a corner 703 having a particular radius of curvature defined by a radius of a best-fit circle relative to the curvature of the corner 703. The body 701 may include a major surface corner radius of curvature, which may be calculated from a single corner or as an average of the radius of curvature of all the corners of a single major surface of a shaped abrasive particle (e.g., three corners of the major surface of the body 701). Additionally, the major surface corner radius of curvature value may be an average value from a statistically relevant sample size of shaped abrasive particles of a batch. Radius of curvature of the corners is calculated on optical images taken with an Olympus DSX microscope. The particle is viewed from a suitable orientation (i.e., top-down to view the major surface corners and from the side to evaluate the side corners) and using computer software equipped on the microscope, a best-fit circle is created in the corner to be measured. The best-fit circle is created such that the maximum length of curvature of a corner corresponds to a maximum length of the circumference of the best-fit circle. The radius of the best-fit circle defines the radius of curvature of the corner.

The shaped abrasive particles of the embodiments herein can have a particular major surface corner radius of curvature that may facilitate certain performance properties. In accordance with an embodiment, the major surface corner radius of curvature can be at least about 100 microns, such as at least about 120 microns, at least about 140 microns, at least about 160 microns, at least about 180 microns, such as at least about 190 microns, at least about 200 microns, at least about 210 microns, at least about 220 microns, at least about 230 microns, at least about 240 microns, at least about 250 microns, at least about 260 microns, at least about 270 microns, at least about 280 microns, or even at least about 290 microns. Still, the major surface corner radius of curvature for the body can be not greater than about 800 microns, such as not greater than about 700 microns, such as not greater than about 600 microns, not greater than about 500 microns, or even not greater than about 400 microns. It will be appreciated that the shaped abrasive particles of the embodiments herein may have a body having a major surface corner radius of curvature within a range between any of the minimum and maximum values noted above.

In yet another embodiment, the shaped abrasive particles of the embodiments herein can have a body having a particular side surface corner radius of curvature. FIG. 7B includes a side view of a shaped abrasive particle according to an embodiment. The body 701 can have a major surface 702, a major surface 713 opposite the major surface 702, and a side surface 705 extending between the major surfaces 702 and 703. As further illustrated, the body 701 can have a first side surface corner 706 defining an edge between one of the major surfaces (e.g., the major surface 713) and the side surface 705. The corner 706 can have a particular radius of curvature defined by a radius of a best-fit circle relative to the curvature of the corner 706. The body 701 may include a side surface corner radius of curvature, which may be calculated from a single corner of the body 701 or as an average of the radius of curvature of all the corners defining a corner between one or more major surfaces and one or more side surfaces of the body 701 of the shaped abrasive particle. Additionally, the side surface corner radius of curvature value may be an average value from a statistically relevant sample size of shaped abrasive particles of a batch.

The shaped abrasive particles of the embodiments herein can have a particular side surface corner radius of curvature that may facilitate certain performance properties. In accordance with an embodiment, the side surface corner radius of curvature can be not greater than about 800 microns, such as not greater than about 700 microns, not greater than about 600 microns, not greater than about 500 microns, not greater than about 400 microns, not greater than about 300 microns, not greater than about 200 microns, not greater than about 280 microns, not greater than about 260 microns, not greater than about 240 microns, not greater than about 220 microns, not greater than about 200 microns, not greater than about 180 microns, not greater than about 160 microns, not greater than about 140 microns, not greater than about 100 microns, not greater than about 80 microns, or even not greater than about 60 microns. Still, it will be appreciated that the body may have a side surface corner radius of curvature that is at least about 1 micron, such as at least about 3 microns, at least about 6 microns, at least about 10 microns, at least about 12 microns, at least about 15 microns, at least about 20 microns, or even at least about 25 microns. It will be appreciated that the shaped abrasive particles herein can have a body having a side surface corner radius of curvature within a range between any of the minimum and maximum values noted above.

The shaped abrasive particles of the embodiments herein can have a particular relationship between the major surface corner radius of curvature and side surface corner radius of curvature that may facilitate certain performance. In one instance, the body can have a major surface corner radius of curvature that is different than the side surface corner radius of curvature. For example, the major surface corner radius of curvature of the body can be greater than the side surface corner radius of curvature of the body. In another embodiment, the major surface corner radius of curvature can be less than the side surface corner radius of curvature. Still, in one non-limiting embodiment, the major surface corner radius of curvature can be substantially the same as the side surface corner radius of curvature.

Furthermore, the body may have a particular ratio SSCR/MSCR, which can define a ratio between a side surface corner radius of curvature (SSCR) to a major surface corner radius of curvature (MSCR). As noted herein, the ratio may be based upon a single major surface corner radius of curvature value, a single side surface corner radius of curvature value, an average major surface corner radius of curvature value, or an average side surface corner radius of curvature value. In one particular embodiment, the ratio (SSCR/MSCR) can be not greater than about 1, such as not greater than about 0.9, not greater than about 0.8, not greater than about 0.7, not greater than about 0.6, not greater than about 0.5, not greater than about 0.4, not greater than about 0.2, not greater than about 0.1, or even not greater than about 0.09. Still, in one non-limiting embodiment, the body can have a ratio SSCR/MSCR of at least about 0.001, at least about 0.005, at least about 0.01 It will be appreciated that the body of the shaped abrasive particles herein can define a ratio (SSCR/MSCR) that is within a range between any of the minimum and maximum values noted above.

Without wishing to be tied to a particular theory, it is noted that a planar portion 710 of the body 701 on the side surface 705 between the first side surface corner 706 and a second side surface corner 709 may have a particular length that can facilitate performance associated with the shaped abrasive particles of the embodiments herein. Moreover, the planar portion 710 can have a length along the side surface 705 between the corners 706 and 709 that may be less than or equal to the first side surface corner 706 radius of curvature or second side surface corner 709 radius of curvature, and such a length may affect grinding performance. Notably, the length of the planar portion 710 may be controlled to control the grinding efficiency of the shaped abrasive particle in the major surface orientation and the side surface orientation. It is also noted that the first side surface corner 706 radius of curvature may be the same as, or different from, the second side surface corner 709 radius of curvature. In another embodiment, the length of the planar portion 710 can be not greater than about 99%, such as not greater than about 95%, not greater than about 90%, not greater than about 80%, not greater than about 70%, not greater than about 60%, not greater than about 50%, not greater than about 40%, not greater than about 30%, not greater than about 20%, not greater than about 10%, not greater than about 8%, not greater than about 6%, or even not greater than about 4% of the radius of curvature of a side surface corner radius of curvature. In another non-limiting embodiment, the planar portion 710 can have a length of at least about 1%, such as at least about 5%, at least about 10%, at least about 20%, at least about 30%, at least about 40%, at least about 50%, at least about 60%, or even at least about 70% of the radius of curvature of at least one side surface corner radius of curvature. It will be appreciated, that the planar portion 710 can have a length relative to the average side surface corner radius of curvature obtained from averaging the radius of curvature of two or more side surface corners.

In one aspect, a shaped abrasive particle according the embodiments herein can have a particular grinding performance associated with a particular grinding orientation, which can be measured according to a standardized single grit grinding test (SGGT). In conducting the SGGT, one single shaped abrasive particle is held in a grit holder by a bonding material of epoxy. The shaped abrasive particle is secured in the desired orientation (i.e., major surface orientation or side surface orientation) and moved across a workpiece of 304 stainless steel for a scratch length of 8 inches using a wheel speed of 22 m/s and an initial scratch depth of 30 microns. The shaped abrasive particle produces a groove in the workpiece having a cross-sectional area (A_{R}). For each sample set, each shaped abrasive particle completes 15 passes across the 8 inch length, 10 individual particles are tested for each of the orientation and the results are analyzed. The test measures the tangential force exerted by the grit on the workpiece, in the direction that is parallel to the surface of the workpiece and the direction of the groove, and the net change in the cross-sectional area of the groove from beginning to the end of the scratch length is measured to determine the shaped abrasive particle wear. The net change in the cross-sectional area of the groove for each pass can be measured. For the SGGT, a minimum threshold value of at least 1000 microns for the cross-sectional area of the groove is set for each pass. If the particle fails to form a groove having the minimum threshold cross-sectional area, the data is not recorded for that pass.

The SGGT is conducted using two different orientations of the shaped abrasive particles relative to the workpiece. The SGGT is conducted with a first sample set of shaped abrasive particles in a major surface orientation, wherein a major surface of each shaped abrasive particle is oriented perpendicular to the grinding direction and such that the major surface initiates grinding on the workpiece. The results of the SGGT using the sample set of shaped abrasive particles in a major surface orientation allows for measurement of the grinding efficiency of the shaped abrasive particles in a major surface orientation and calculation of a major surface grinding efficiency upper quartile value (MSUQ), a major surface grinding efficiency median value (MSM), and a major surface grinding efficiency lower quartile value (MSLQ).

The SGGT is also conducted with a second sample set of shaped abrasive particles in a side surface orientation, wherein a side surface of each shaped abrasive particle is oriented perpendicular to the grinding direction and such that the side surface initiates grinding of the workpiece. The results of the SGGT test using the sample set of shaped abrasive particles in a side orientation allows for measurement of the grinding efficiency of the shaped abrasive particles in a side orientation and calculation of a side surface grinding efficiency upper quartile value (SSUQ), a side surface grinding efficiency median value (SSM), and a side surface grinding efficiency lower quartile value (SSLQ).

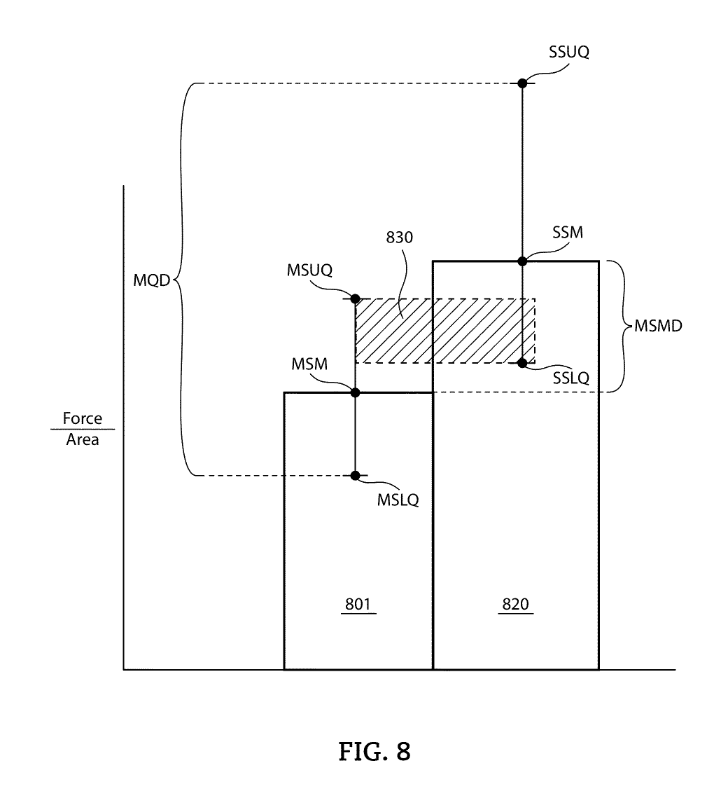

FIG. 8 includes a generalized plot of force per total area removed from the workpiece, which is representative of data derived from the SGGT. The force per total area removed is a measure of the grinding efficiency of the shaped abrasive particles, with lower force per total area removed as an indication of more efficient grinding performance. As illustrated, FIG. 8 includes a first bar 801 representing SGGT data for the first sample set of shaped abrasive particles positioned in the major surface orientation, and thus defining the major surface grinding efficiency upper quartile value (MSUQ), the major surface grinding efficiency median value (MSM), and the major surface grinding efficiency lower quartile value (MSLQ). FIG. 8 also includes a second bar 820 representing SGGT data for the second sample set of shaped abrasive particles, where the particles are the same type of particles as used in the first sample set (i.e., same composition and shape features), but are tested in the side orientation. As illustrated, the SGGT data from the second set provides the side surface grinding efficiency upper quartile value (SSUQ), the side surface grinding efficiency median value (SSM), and the side surface grinding efficiency lower quartile value (SSLQ) for the shaped abrasive particles of the second sample set.

In accordance with one embodiment, the shaped abrasive particles herein can have a major surface grinding efficiency (i.e., MSM) that can be less than the side surface grinding efficiency (SSM) according to the SGGT. That is, the shaped abrasive particles of the embodiments herein can have a grinding efficiency using a major surface that is much better as compared to the grinding efficiency of the shaped abrasive particles on the side surface. Still, it will be appreciated, that in other instances, the shaped abrasive particles of the embodiments herein can have a SSM that is less than a MSM according to the SGGT.

In one aspect, the shaped abrasive particles of the embodiments herein can have a major surface grinding efficiency upper quartile value (MSUQ), which can be a value defining the values of force per unit area for lowest 75% of the data points and excluding the uppermost 25% of values within the data set from measurements according to the SGGT. In accordance with one embodiment, the MSUQ can be not greater than about 8.3 kN/mm², such as not greater than about 8 kN/mm², not greater than about 7.8 kN/mm², not greater than about 7.5 kN/mm², not greater than about 7.2 kN/mm², not greater than about 7 kN/mm², not greater than about 6.8 kN/mm², not greater than about 6.5 kN/mm², not greater than about 6.2 kN/mm², not greater than about 6 kN/mm², not greater than about 5.5 kN/mm², not greater than about 5.2 kN/mm², or even not greater than about 4 kN/mm². Still, in one non-limiting embodiment, the MSUQ can be at least about 0.1 kN/mm². It will be appreciated that the MSUQ can be within range between any of the minimum and maximum values noted above.

In accordance with another embodiment, the shaped abrasive particles herein can have a major surface grinding efficiency median value (MSM), which can define the median value of the major surface grinding efficiency for the first sample set of shaped abrasive particles tested according to the SGGT. The MSM can have a particular value relative to the MSUQ. For example, the MSM can be less than the MSUQ. In one particular embodiment, the MSM can have a median value that is not greater than about 8 kN/mm², such as not greater than about 7.8 kN/mm², not greater than about 7.5 kN/mm², not greater than about 7.2 kN/mm², not greater than about 7 kN/mm², not greater than about 6.8 kN/mm², not greater than about 6.5 kN/mm², not greater than about 6.2 kN/mm², not greater than about 6 kN/mm², not greater than about 5.8 kN/mm², not greater than about 5.5 kN/mm², not greater than about 5.2 kN/mm², not greater than about 5 kN/mm², not greater than about 4.8 kN/mm², not greater than about 4.6 kN/mm², not greater than about 4.2 kN/mm², not greater than about 4 kN/mm², not greater than about 3.8 kN/mm², not greater than about 3.6 kN/mm², not greater than about 3.2 kN/mm², not greater than about 3 kN/mm², not greater than about 2.8 kN/mm², or even not greater than about 2.6 kN/mm². Still, it will be appreciated that certain shaped abrasive particles herein can have a major surface grinding efficiency median value (MSM) of at least about 0.1 kN/mm². It will be appreciated that the shaped abrasive particles herein can have a MSM within a range between any of the minimum and maximum values noted above.

In yet another embodiment, the shaped abrasive particles herein can have a particular major surface grinding efficiency lower quartile value (MSLQ), which can be a value defining the values of force per unit area for the uppermost 75% of the data points and excluding the lowest 25% of values within the data set from measurements according to the SGGT. In at least one embodiment, the MSLQ can have a relative value compared to the MSM. For example, the MSLQ can be less than the MSM. In another embodiment, the MSLQ can be not greater than about 8 kN/mm², such as not greater than about 7 kN/mm², not greater than about 6.5 kN/mm², not greater than about 6.2 kN/mm², not greater than about 6 kN/mm², not greater than about 5.8 kN/mm², not greater than about 5.5 kN/mm², not greater than about 5.2 kN/mm², not greater than about 5 kN/mm², not greater than about 4.8 kN/mm², not greater than about 4.6 kN/mm², not greater than about 4.2 kN/mm², not greater than about 4 kN/mm², not greater than about 3.8 kN/mm², not greater than about 3.6 kN/mm², not greater than about 3.2 kN/mm², not greater than about 3 kN/mm², not greater than about 2.8 kN/mm², not greater than about 2.6 kN/mm², not greater than about 2.2 kN/mm², not greater than about 2 kN/mm², not greater than about 1.9 kN/mm². In yet another embodiment, the MSLQ can be at least about 0.1 kN/mm². It will be appreciated that the shaped abrasive particles herein can have a MSLQ within any of the minimum and maximum values noted above.

In yet another embodiment, the shaped abrasive particles herein can have a particular side surface grinding efficiency upper quartile value (SSUQ), which can be a value defining the values of force per unit area for the lowest 75% of the data points, excluding the upper-most 25% of values within the data set from measurements according to the SGGT. In accordance with an embodiment, the SSUQ can be at least about 4.5 kN/mm², such as at least about 5 kN/mm², at least about 5.5 kN/mm², at least about 6 kN/mm², at least about 6.5 kN/mm², at least about 7 kN/mm², at least about 7.5 kN/mm², at least about 8 kN/mm², at least about 8.5 kN/mm², at least about 9 kN/mm², at least about 10 kN/mm², at least about 15 kN/mm², at least about 20 kN/mm², or even at least about 25 kN/mm². Still, in one non-limiting embodiment, the SSUQ can be not greater than about 100 kN/mm². It will be appreciated that the shaped abrasive particles herein can have an SSUQ according to the SSGT that is within a range between any of the minimum or maximum values noted above.

In accordance with another embodiment, shaped abrasive particles herein can have a particular side surface grinding efficiency median value (SSM), which can be a measure of the median value of the side surface grinding efficiency as calculated from the SGGT. The SSM may have a particular value relative to the SSUQ, and more particularly may be less than the SSUQ. In one particular embodiment, the shaped abrasive particles herein can have an SSM that is at least about 3 kN/mm², at least about 3.2 kN/mm², at least about 3.5 kN/mm², at least about 3.7 kN/mm², at least about 4 kN/mm², at least about 4.2 kN/mm², at least about 4.5 kN/mm², at least about 4.7 kN/mm², at least about 5 kN/mm², at least about 5.2 kN/mm², at least about 5.5 kN/mm², at least about 5.7 kN/mm², at least about 6 kN/mm², at least about 6.2 kN/mm², at least about 6.5 kN/mm², at least about 7 kN/mm², at least about 8 kN/mm², at least about 9 kN/mm², at least about 10 kN/mm². In still another embodiment, the shaped abrasive particles herein can have an SSM that is not greater than about 100 kN/mm². It will be appreciated that the shaped abrasive particles herein can have a SSM within a range between any of the minimum and maximum values noted above.

Additionally, the shaped abrasive particles herein may have a side surface grinding efficiency lower quartile value (SSLQ), which can be a value defining the values of force per unit area for the uppermost 75% of the data point, excluding the lowest 25% of values within the data set from measurements according to the SGGT. In accordance with an embodiment, the SSLQ may have a particular relationship to the SSM, and more particularly may be less that the SSM. In at least one embodiment, the shaped abrasive particles herein can have a SSLQ that is at least about 2.5 kN/mm², such as at least about 2.7 kN/mm², at least about 3 kN/mm², at least about 3.1 kN/mm², at least about 3.3 kN/mm², at least about 3.5 kN/mm², at least about 3.6 kN/mm², at least about 3.8 kN/mm², at least about 4 kN/mm², at least about 5 kN/mm², at least about 6 kN/mm². In yet another embodiment, the shaped abrasive particles herein may have a SSLQ that is not greater than about 100 kN/mm². It will be appreciated that the shaped abrasive particles herein can have an SSLQ that is within range between any of the minimum and maximum values noted above.

In accordance with one embodiment, the shaped abrasive particles herein can have a major surface-to-side surface grinding orientation percent difference (MSGPD) of at least about 40%. The MSGPD can describe the percent difference between the major surface grinding efficiency median value (MSM) and the side surface grinding efficiency median value (SSM). If the MSM is greater than the SSM, then the MSGPD is calculated using the equation MSGPD=[(MSM-SSM)/MSM]×100%, wherein MSM is greater than SSM. If the SSM is greater than the MSM, then the MSGPD is calculated using the equation MSGPD=[(SSM-MSM)/SSM]×100%. Such a percent difference in the MSGPD may facilitate particular grinding performance in fixed abrasive articles. According to one embodiment, the shaped abrasive particles herein can have a MSGPD of at least about 42%, such as at least about 44%, at least about 46%, at least about 48%, at least about 50%, at least about 52%, at least about 54%, at least about 55%, at least about 56%, at least about 57%, at least about 58%, or even at least about 59%. Still, in one non-limiting embodiment, the shaped abrasive particle may have a MSGPD of not greater than about 99%, such as not greater than about 95%. It will be appreciated that the shaped abrasive particle may have a MSGPD within a range between any of the minimum or maximum percentages noted above.

In yet another embodiment, the shaped abrasive particles herein can have a major surface grinding efficiency median value and side surface grinding efficiency median value difference (MSMD) of at least about 1.9 kN/mm². It will be appreciated that the MSMD may describe the absolute value of the difference between the MSM and SSM, calculated using the equation MSMD=|MSM-SSM|. In another embodiment, the MSMD can be at least about 2 kN/mm², such as at least about 2.3 kN/mm², at least about 2.5 kN/mm², at least about 2.7 kN/mm², at least about 3 kN/mm², at least about 3.5 kN/mm², at least about 4 kN/mm², at least about 4.5 kN/mm², at least about 5 kN/mm², or even at least about 6 kN/mm². Still, in one non-limiting embodiment the MSMD can be not greater than about 50 kN/mm². It will be appreciated that the shaped abrasive particle may have a MSMD within a range between any of the minimum or maximum percentages noted above.

In another aspect, the shaped abrasive particles of the embodiments herein may have a particular maximum quartile-to-median percent difference (MQMPD). The MQMPD can describe the greatest percent difference between one of the median values (e.g., the MSM) and one of the two associated quartile values (i.e., MSUQ, MSLQ, SSUQ, and SSLQ), and can indicate the greatest variance between a median value relative to one of the two corresponding quartile values for the shaped abrasive particles. For example, the MSMPD for the generalized data set illustrated in FIG. 8 would be based upon the percent difference between the SSUQ and SSM. Determination of the MQMPD can include a calculation of the percent difference for the MSUQ relative to the MSM, the MSLQ relative to the MSM, the SSUQ relative to the SSM, and the SSLQ relative to the SSM. The percent difference between of MSUQ relative to MSM is based on the equation [(MSUQ−MSM)/MSUQ]×100%. The percent difference between of MSLQ relative to MSM is based on the equation [(MSM−MSLQ)/MSM]×100%. The percent difference between of SSUQ relative to SSM is based on the equation [(SSUQ−SSM)/SSUQ]×100%. The percent difference between of SSLQ relative to SSM is based on the equation [(SSM−SSLQ)/SSM]×100%. Of the foregoing four percent difference calculations, the percent difference of the greatest value defines the MQMPD of the SGGT data.

According to one embodiment, the shaped abrasive particles herein can have a MQMPD of at least about 48%, such as at least about 49%, such as at least about 50%, at least about 52%, at least about 54%, at least about 56%, or even at least about 58%. In yet another non-limiting embodiment, the shaped abrasive particle may have a MQMPD of not greater than 99%, or even not greater than about 95%. It will be appreciated that the shaped abrasive particles herein can have a MQMPD within a range between any of the above-noted minimum and maximum percentages. Such a percent difference in the MSGPD may facilitate particular grinding performance in fixed abrasive articles.

In another aspect, the shaped abrasive particles of the embodiments herein may have a particular maximum quartile difference (MQD). The MQD can describe the greatest difference between any of the quartile values (i.e., MSUQ, MSLQ, SSUQ, and SSLQ), and can indicate the greatest variation between quartiles for the major orientation or side orientation. For example, the MSD for the generalized data set illustrated in FIG. 8 would be based upon the percent difference between the SSUQ and MSLQ, since the SSUQ has the greatest value of force/area (e.g., kN/mm²) value of the quartile values and the MSLQ has the lowest value of force/area value of the quartile values. In accordance with an embodiment, the shaped abrasive particles herein can have a MQD of at least about 6 kN/mm², such as least about 6.2 kN/mm², at least about 6.5 kN/mm², at least about 6.8 kN/mm², at least about 7 kN/mm², at least about 7.5 kN/mm², at least about 8 kN/mm², at least about 9 kN/mm², at least about 10 kN/mm², or even at least about 12 kN/mm². In one non-limiting embodiment, the shaped abrasive particle may have a MQD of not greater about 100 kN/mm². It will be appreciated that the shaped abrasive particles herein can have a MQD within a range between any of the above-noted minimum and maximum values.

For yet another aspect, the shaped abrasive particles of the embodiments herein may demonstrate a major surface-to-side surface quartile percent overlap (MSQPO), which can describe the degree of overlap between quartiles in the region 830 relative to the maximum quartile difference, and can indicate the variance in the grinding efficiency data between the major surface orientation and the side orientation. For example, the MSQPO for the generalized data set illustrated in FIG. 8 would be based upon the equation [(MSUQ−SSLQ)/MQD]×100%. For shaped abrasive particles of the embodiments herein, the MSQPO can be not greater than about 11%, such as not greater than about 10%, not greater than 9%, not greater than about 8%, not greater than about 7%, not greater than about 6%, not greater than about 5%, not greater than about 4%, not greater than about 3%, not greater than about 2%, or even not greater than about 1%. In one non-limiting embodiment, the shaped abrasive particle may have a MSQPO of at least about 0.1%. It will be appreciated that the shaped abrasive particles herein can have a MSQPO within a range between any of the above-noted minimum and maximum percentages.

It will be appreciated that the degree of overlap between the quartiles may be also be evaluated by calculating the difference between the upper quartile having the lowest value of the two upper quartile data points (of either the major surface or side surface grinding efficiency) and subtracting the value of the lower quartile grinding efficiency having the greatest value between the two lower quartile data points, independent of the orientation. As such, in some instances wherein the upper quartile and lower quartile values of one data set (e.g., the major surface orientation) are between the upper quartile and lower quartile values of the data set for the other orientation (i.e., side surface orientation) the degree of overlap can be 100% and can be the difference between the major surface upper quartile and major surface lower quartile.

In yet another embodiment, the shaped abrasive particles herein can have a major surface to side surface upper quartile percent difference (MSUQPD), which can describe the difference between the upper quartile value associated with the major surface grinding efficiency relative to the upper quartile value associated with the side surface grinding efficiency. For example, the MSUQPD for the generalized data set illustrated in FIG. 8 would be based upon the equation [(SSUQ−MSUQ)/SSUQ]×100%, wherein SSUQ is greater than MSUQ. If MSUQ were greater than SSUQ, the positions of the values in the equation are exchanged to provide a positive percent. In accordance with an embodiment, the MSUQPD can be at least about 54%, such as at least about 55%, at least about 56%, at least about 57%, at least about 58%, at least about 60%, at least about 63%, at least about 65%, or even at least about 70%. In one non-limiting embodiment, the shaped abrasive particle may have a MSUQPD of not greater than about 99%. It will be appreciated that the shaped abrasive particles herein can have a MSUQPD within a range between any of the above-noted minimum and maximum percentages.

According to one aspect, the shaped abrasive particles of the embodiments herein can have a major surface to side surface lower quartile percent difference (MSLQPD), which can describe the difference between the lower quartile value associated with the major surface grinding efficiency relative to the lower quartile value associated with the side surface grinding efficiency. For example, the MSLQPD for the generalized data set illustrated in FIG. 8 would be based upon the equation [(SSLQ−MSLQ)/SSLQ]×100%, wherein SSLQ is greater than MSLQ. If MSLQ were greater than SSLQ, the positions of the values in the equation are exchanged to provide a positive percent. In at least one embodiment, the MSLQPD can be at least about 28%, such as at least about 30%, at least about 32%, at least about 35%, at least about 37%, at least about 40%, at least about 42%, at least about 45%, at least about 47%, at least about 50%, at least about 52%, at least about 55%, or even at least about 57%. In one non-limiting embodiment, the shaped abrasive particle may have a MSLQPD of not greater than about 99%. It will be appreciated that the shaped abrasive particles herein can have a MSLQPD within a range between any of the above-noted minimum and maximum percentages.

While reference has been made herein to grinding characteristics of the shaped abrasive particles according to the SGGT, it will be appreciated that such values can represent median values for a batch of abrasive particles, a first portion of a batch of shaped abrasive particles, or a plurality of shaped abrasive particles. In particular, it will be appreciated that any of the characteristics of the embodiments herein, including the grinding characteristics can be representative of a batch of shaped abrasive particles. Such grinding characteristics include, but are not limited to, a major surface grinding efficiency upper quartile value (MSUQ), a major surface grinding efficiency median value (MSM), a major surface grinding efficiency lower quartile value (MSLQ), a side surface grinding efficiency upper quartile value (SSUQ), a side surface grinding efficiency median value (SSM), a side surface grinding efficiency lower quartile value (SSLQ), a major surface-to-side surface grinding orientation percent difference (MSGPD), a maximum quartile-to-median percent difference (MQMPD), a maximum quartile difference (MQD), a major surface-to-side surface quartile percent overlap (MSQPO), a major surface grinding efficiency median value and side surface grinding efficiency median value difference (MSMD), a major surface-to-side surface upper quartile percent difference (MSUQPD), a major surface-to-side surface lower quartile percent difference (MSLQPD), and a combination thereof.

In one particular embodiment, a batch of shaped abrasive particles may include a first portion including a plurality of shaped abrasive particles, wherein the shaped abrasive particles of the first portion comprise a first grinding characteristic according to the SGGT. For example, the first portion can include a plurality of shaped abrasive particles defining one or more first grinding characteristics according to the SGGT, such as a first major surface grinding efficiency upper quartile value (MSUQ1), a first major surface grinding efficiency median value (MSM1), a first major surface grinding efficiency lower quartile value (MSLQ1), a first side surface grinding efficiency upper quartile value (SSUQ1), a first side surface grinding efficiency median value (SSM1), a first side surface grinding efficiency lower quartile value (SSLQ1), a first major surface-to-side surface grinding orientation percent difference (MSGPD1), a first maximum quartile-to-median percent difference (MQMPD1), a first maximum quartile difference (MQD1), a first major surface-to-side surface quartile percent overlap (MSQPO1), a first major surface grinding efficiency median value and side surface grinding efficiency median value difference (MSMD1), a first major surface-to-side surface upper quartile percent difference (MSUQPD1), a first major surface-to-side surface lower quartile percent difference (MSLQPD1), and a combination thereof.

Moreover, the batch can include a second portion of abrasive particles that can be distinct from the first portion. In particular instances, the second portion of abrasive particles can include a plurality of abrasive particles, which may be a plurality of shaped abrasive particles, having one or more second grinding characteristics significantly distinct from the first grinding characteristics. The second grinding characteristics can include any of the features described herein, including, but are not limited to, a second major surface grinding efficiency upper quartile value (MSUQ2), a second major surface grinding efficiency median value (MSM2), a second major surface grinding efficiency lower quartile value (MSLQ2), a second side surface grinding efficiency upper quartile value (SSUQ2), a second side surface grinding efficiency median value (SSM2), a second side surface grinding efficiency lower quartile value (SSLQ2), a second major surface-to-side surface grinding orientation percent difference (MSGPD2), a second maximum quartile-to-median percent difference (MQMPD2), a second maximum quartile difference (MQD2), a second major surface-to-side surface quartile percent overlap (MSQPO2), a second major surface grinding efficiency median value and side surface grinding efficiency median value difference (MSMD2), a second major surface-to-side surface upper quartile percent difference (MSUQPD2), a second major surface-to-side surface lower quartile percent difference (MSLQPD2), and a combination thereof.

In certain instances, the batch including the first portion of abrasive particles having the first grinding characteristic and the second portion of abrasive particles having the second grinding characteristics can have a difference between corresponding grinding characteristics of at least about 2%. For example, the batch may include a first portion having a particular first major surface grinding efficiency median value (MSM1) and the second portion can have a particular second major surface grinding efficiency median value (MSM2), which can be distinct from the MSM1 by at least about 2%, wherein the percent difference is calculated by the equation [(MSM1−MSM2)/MSM1]×100%, wherein MSM1 is greater than MSM2. If MSM2 is greater than MSM1, the equation used is [(MSM2−MSM1)/MSM2]×100%. In other embodiments, the difference between the first grinding characteristic and the second corresponding grinding characteristic can be at least about 5%, such as at least about 8%, at least about 10%, at least about 12%, at least about 25%, at least about 18%, at least about 20%, at least about 22%, or even at least about 25%. It will be appreciated that such a percent difference between any of the corresponding grinding characteristics of the first portion and second portion can be calculated in the same manner.

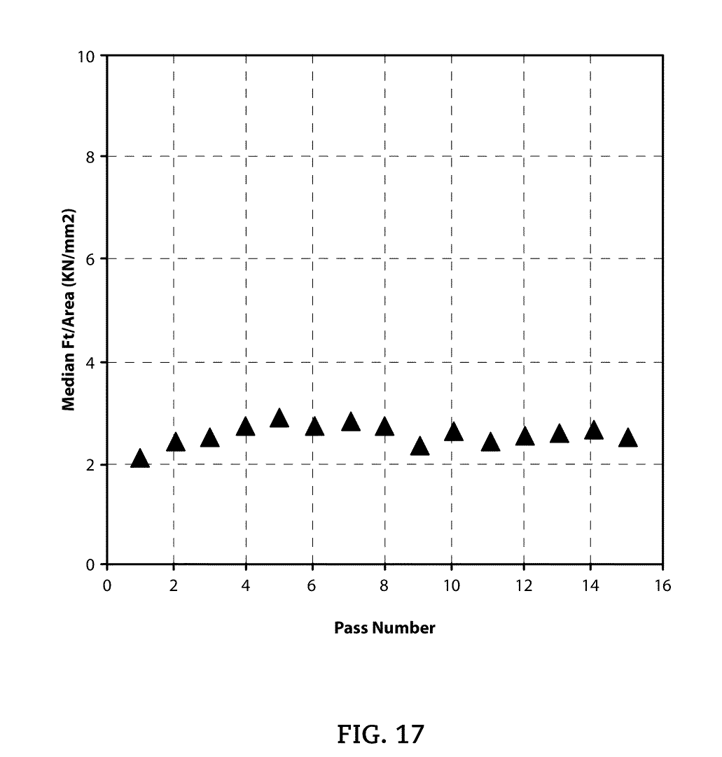

The grinding efficiency of a particular shaped abrasive particle may be evaluated over time according to the SGGT. Notably, the tangential force can be plotted with respect to time to provide information on the change in grinding efficiency of the shaped abrasive particle through the duration of the SGGT. In accordance with one embodiment the maximum difference in force between a maximum force and minimum force on a plot of tangential force versus time for a shaped abrasive particle can define a grinding efficiency time variance. It will be appreciated that the grinding efficiency time variance can be measured for the major surface orientation and/or the side surface orientation. FIG. 17 includes a plot of grinding efficiency versus time for a shaped abrasive particle according to an embodiment. Notably, in one instance, the shaped abrasive particles of the embodiments herein can have a major surface grinding efficiency time variance (MSTV) of not greater than about 2 kN/mm², as measured by the difference between the value of the data point on the plot representing the greatest force minus value of the data point of the plot representing the lowest force. In other instances, the MSTV can be not greater than about 1.8 kN/mm², not greater than about 1.5 kN/mm², not greater than about 1.2 kN/mm², not greater than about 1.1 kN/mm², not greater than about 1 kN/mm², not greater than about 0.9 kN/mm², not greater than about 0.8 kN/mm². Still, in one non-limiting embodiment, the MSTV can be not at least about 0.01 kN/mm². It will be appreciated that the shaped abrasive particles herein can have an MSTV according to the SSGT that is within a range between any of the minimum or maximum values noted above.

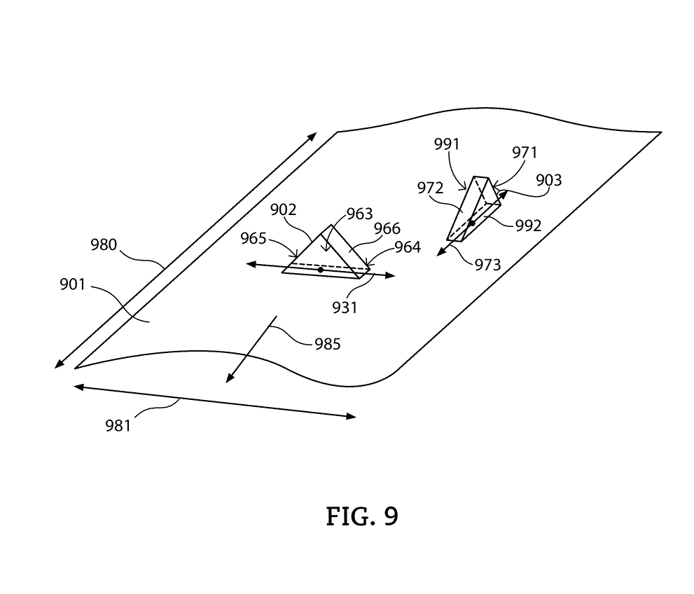

FIG. 9 includes a perspective view illustration of a portion of an abrasive article including shaped abrasive particles having predetermined orientation characteristics relative to a grinding direction in accordance with an embodiment. In one embodiment, the abrasive article can include a shaped abrasive particle 902 having a predetermined orientation relative to another shaped abrasive particle 903 and/or relative to a grinding direction 985. Control of one or a combination of predetermined orientation characteristics relative to the grinding direction 985 may facilitate improved grinding performance of the abrasive article. In particular, the control of the rotational orientation of the shaped abrasive particles 902 and 903 in combination with control of the major surface grinding efficiency and side surface grinding efficiency can facilitate formation of fixed abrasive articles having unique performance. It is contemplated that by understanding and controlling the major surface grinding efficiency and side surface grinding efficiency of shaped abrasive particles, and further by controlling the orientation of the shaped abrasive particles relative to the backing 901 and a grinding direction 985, the fixed abrasive article may be more properly tailored to various applications.

The grinding direction 985 may be an intended direction of movement of the abrasive article relative to a workpiece in a material removal operation. In particular instances, the grinding direction 985 may be related to the dimensions of the backing 901. For example, in one embodiment, the grinding direction 985 may be substantially perpendicular to the lateral axis 981 of the backing and substantially parallel to the longitudinal axis 980 of the backing 901. The predetermined orientation characteristics of the shaped abrasive particle 902 may define an initial contact surface of the shaped abrasive particle 902 with a workpiece. For example, the shaped abrasive particle 902 can have a major surfaces 963 and 964, and side surfaces 965 and 966 extending between the major surfaces 963 and 964. The predetermined orientation characteristics of the shaped abrasive particle 902 can position the particle such that the major surface 963 is configured to make initial contact with a workpiece before the other surfaces of the shaped abrasive particle 902. Such an orientation may be considered a major surface orientation relative to the grinding direction 985. More particularly, the shaped abrasive particle 902 can have a bisecting axis 931 having a particular orientation relative to the grinding direction. For example, as illustrated, the vector of the grinding direction 985 and the bisecting axis 931 are substantially perpendicular to each other. It will be appreciated that just as any range of predetermined rotational orientations are contemplated for a shaped abrasive particle, any range of orientations of the shaped abrasive particles relative to the grinding direction 985 are contemplated and can be utilized. Such an orientation as shown for the shaped abrasive particle 902 may be particularly suitable for shaped abrasive particles having a major surface grinding efficiency that is better than a side surface grinding efficiency. It will be appreciated that for such particles, a coated abrasive article may include a significant portion of the shaped abrasive particles in a major surface orientation relative to the grinding direction 985.

The shaped abrasive particle 903 can have different predetermined orientation characteristics relative to the shaped abrasive particle 902 and the grinding direction 985. As illustrated, the shaped abrasive particle 903 can include major surfaces 991 and 992, which can be joined by side surfaces 971 and 972. Moreover, as illustrated, the shaped abrasive particle 903 can have a bisecting axis 973 forming a particular angle relative to the vector of the grinding direction 985. As illustrated, the bisecting axis 973 of the shaped abrasive particle 903 can have a substantially parallel orientation with the grinding direction 985 such that the angle between the bisecting axis 973 and the grinding direction 985 is essentially 0 degrees. Accordingly, the predetermined orientation characteristics of the shaped abrasive particle facilitate initial contact of the side surface 972 with a workpiece before any of the other surfaces of the shaped abrasive particle. Such an orientation of the shaped abrasive particle 903 may be considered a side surface orientation relative to the grinding direction 985. Such an orientation as illustrated for the shaped abrasive particle 903 may be particularly suitable for shaped abrasive particles having a side surface grinding efficiency that is better than a major surface grinding efficiency. It will be appreciated that for such particles, a coated abrasive article may include a significant portion of the shaped abrasive particles in a side surface orientation relative to the grinding direction 985.

It will be appreciated that the abrasive article can include one or more groups of shaped abrasive particles that can be arranged in a predetermined distribution relative to each other, and more particularly can have distinct predetermined orientation characteristics that define groups of shaped abrasive particles. The groups of shaped abrasive particles, as described herein, can have a predetermined orientation relative to a grinding direction. Moreover, the abrasive articles herein can have one or more groups of shaped abrasive particles, each of the groups having a different predetermined orientation relative to a grinding direction. Utilization of groups of shaped abrasive particles having different predetermined orientations relative to a grinding direction can facilitate improved performance of the abrasive article.

### Example 1

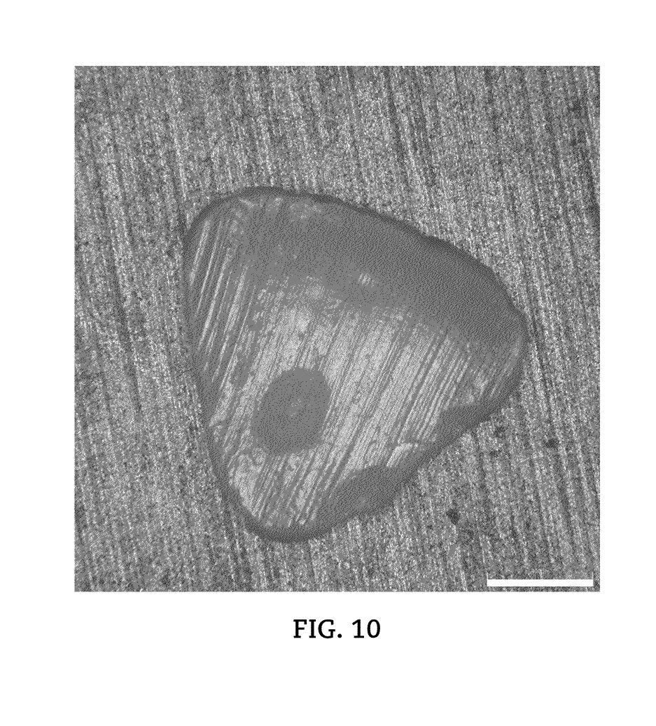

Five samples of shaped abrasive particles were analyzed using SGGT. A first sample, Sample S1, includes shaped abrasive particles made from a seeded sol-gel, having an average major surface radius of curvature of approximately 300 microns, an average side corner radius of curvature of approximately 30 microns, a ratio of SSCR/MSCR of approximately 0.075, a height of approximately 400 microns, and a flashing percentage of approximately 4%. FIG. 10 includes an image of a representative shaped abrasive particle from Sample S1.

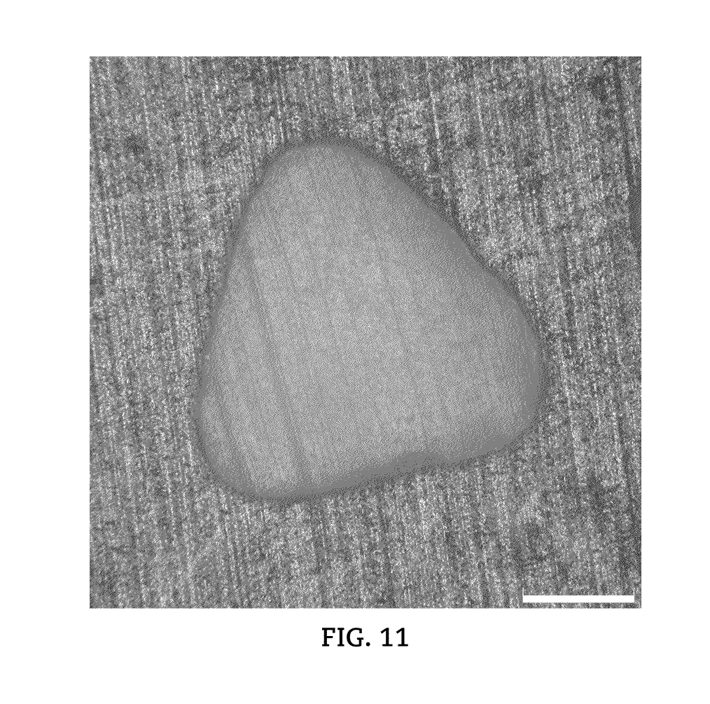

A second sample, Sample S2, includes shaped abrasive particles having a rare-earth element doped alpha-alumina composition, an average major surface radius of curvature of approximately 300 microns, an average side corner radius of curvature of approximately 30 microns, a ratio of SSCR/MSCR of approximately 0.075, a height of approximately 400 microns, a flashing percentage of approximately 4%. FIG. 11 includes an image of a representative shaped abrasive particle from Sample S2.

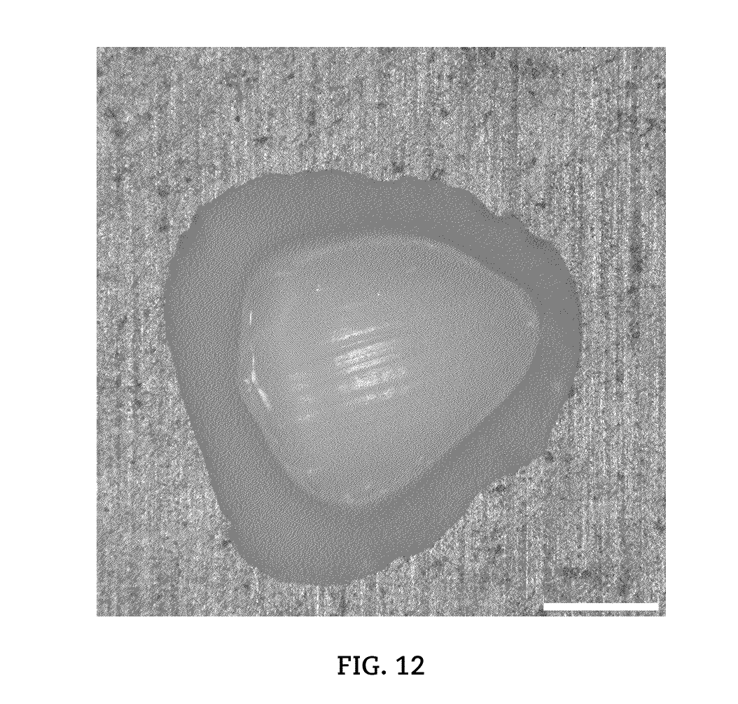

A third sample, Sample S3, includes shaped abrasive particles made from a seeded sol-gel, having an average major surface radius of curvature of approximately 500 microns, an average side corner radius of curvature of approximately 30 microns, a ratio of SSCR/MSCR of approximately 0.06, a height of approximately 500 microns, and a flashing percentage of approximately 16%. FIG. 12 includes an image of a representative shaped abrasive particle from Sample S3.

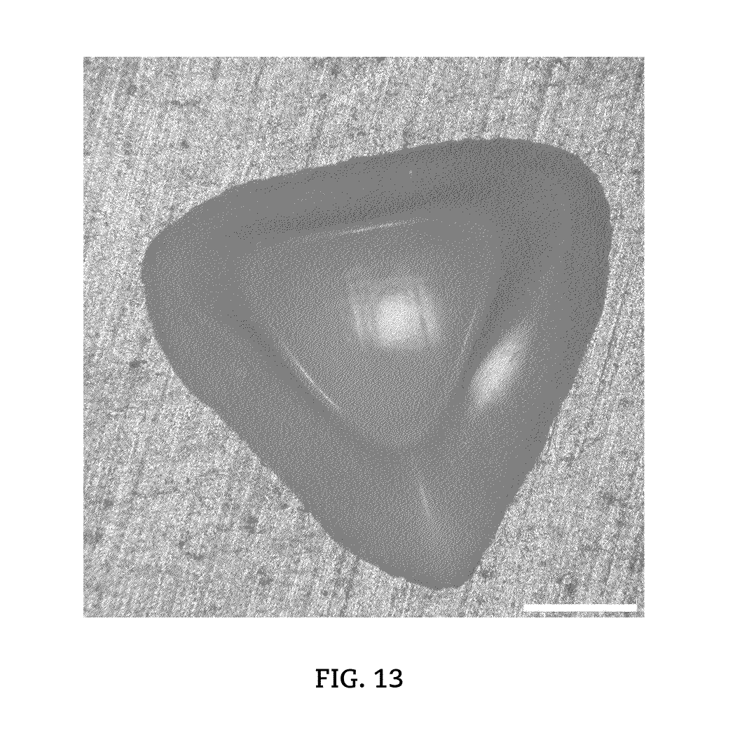

A fourth sample, Sample S4, includes shaped abrasive particles having a rare-earth element doped alpha-alumina composition, an average major surface radius of curvature of approximately 500 microns, an average side corner radius of curvature of approximately 30 microns, a ratio of SSCR/MSCR of approximately 0.06, a height of approximately 500 microns, and a flashing percentage of approximately 17%. FIG. 13 includes an image of a representative shaped abrasive particle from Sample S4.

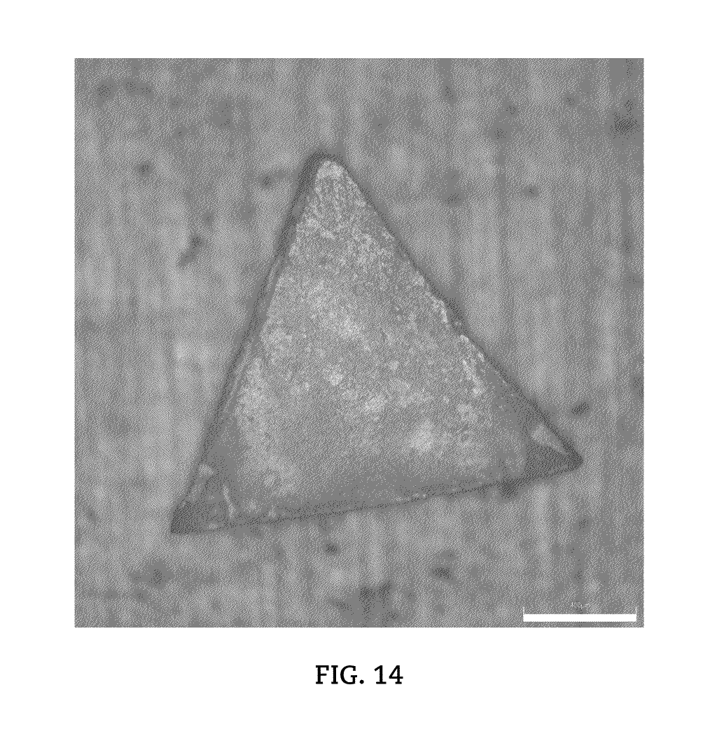

A conventional sample, Sample CS1, is a sample of Cubitron II shaped abrasive particles commercially available as 3M984F from 3M Corporation. The shaped abrasive particles of Sample CS1 had a rare-earth element doped alpha-alumina composition, an average major surface radius of curvature of approximately 30 microns, an average side corner radius of curvature of approximately 30 microns, a ratio of SSCR/MSCR of approximately 1, a height of approximately 260 microns, and a flashing percentage of approximately 4%. FIG. 14 includes an image of a representative shaped abrasive particle from Sample CS1.

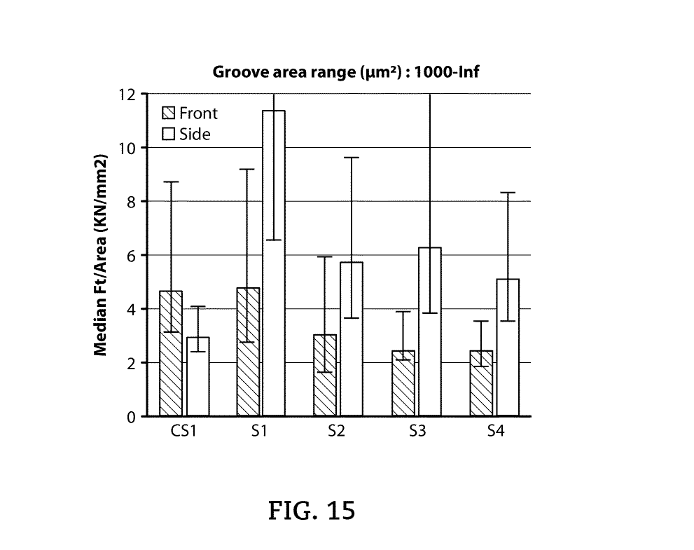

All samples were tested according to the SGGT in a major surface orientation and side orientation. The results of the data are provided in FIG. 15, which includes a plot of major surface grinding efficiency and side surface grinding efficiency for each of the samples. Sample CS1 had a MSGPD of 37, a MQD of about 6, a MSQPO of 12, a MSMD of 1.7, a MQMPD of 47, a MSUQPD of 54, a MSLQPD of 27, and a MSTV of 2.8.

By contrast, Sample S1 had a MSGPD of 57, a MQD of 23, a MSQPO of about 12, a MSMD of 6.6, a MQMPD of 57, a MSUQPD of 65, and a MSLQPD of 58. Sample S2 had a MSGPD of 47, a MQD of 8, a MSQPO of about 28, a MSMD of 2.7, and a MQMPD of 50, a MSUQPD of 39, and a MSLQPD of 56. Sample S3 had a MSGPD of 61, a MQD of 17, a MSQPO of about 0.3, a MSMD of 3.9, and a MQMPD of 66, a MSUQPD of 79, a MSLQPD of 47, and a MSTV of 0.7. Sample S4 had a MSGPD of 53, a MQD of 7, a MSQPO of about 0.2, a MSMD of 2.7, and a MQMPD of 38, a MSUQPD of 58, a MSLQPD of 48, and a MSTV of 1.4.

Furthermore, by comparison, each of Samples S1-S4 had a major surface grinding efficiency that was equal to or better than that of Sample CS1. In particular, the MSM values of Samples S3 and S4 were nearly twice as good as compared to the MSM value of Sample CS1 (i.e., half of the force per area median value). Moreover, each of the Samples S1-S4 had SSM values that were significantly greater than the corresponding MSM values. Samples S1-S4 had SSM values that were approximately twice as great as the corresponding MSM values. By contrast, Sample CS1 had a SSM value less than the MSM value, and more particularly, about 40% less than the MSM value.

The present application represents a departure from the state of the art. The shaped abrasive particles and fixed abrasive articles of the embodiments herein include a particular combination of features distinct from other articles. For example, the particles demonstrate remarkable and unexpected performance in terms of MSUQ, MSM, MSLQ, SSUQ, SSM, SSLQ, MSGPD, MQMPD, MQD, MSQPO, MSMD, MSUQPD, MSLQPD, MSTV, and a combination thereof. Moreover, while not completely understood and not wishing to be tied to a particular theory, it is thought that one or a combination of features of the embodiments herein facilitate the performance of the shaped abrasive particles, including but not limited to, aspect ratio, composition, additives, two-dimensional shape, three-dimensional shape, difference in height, difference in height profile, flashing percentage, height, dishing, major surface corner radius of curvature, side surface corner radius of curvature, SSCR/MSCR ratio, relative side of a planar portion, and a combination thereof.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description of the Drawings, with each claim standing on its own as defining separately claimed subject matter.

Items

Item 1. A shaped abrasive particle comprising a major surface-to-side surface grinding orientation percent difference (MSGPD) of at least about 40%.

Item 2. A shaped abrasive particle comprising a maximum quartile-to-median percent difference (MQMPD) of at least about 48%.

Item 3. A batch of abrasive particles comprising a first portion including a plurality of shaped abrasive particles having a major surface-to-side surface grinding orientation percent difference (MSGPD) of at least about 40%.

Item 4. A batch of abrasive particles comprising a first portion including a plurality of shaped abrasive particles having a maximum quartile-to-median percent difference (MQMPD) of at least about 48%.

Item 5. A shaped abrasive particle comprising a major surface grinding efficiency median value (MSM) of not greater than about 4 kN/mm2.

Item 6. The shaped abrasive particle or batch of abrasive particles of any of items 1 and 3, wherein the shaped abrasive particle comprises a maximum quartile-to-median percent difference (MQMPD) of at least about 48%.

Item 7. The shaped abrasive particle or batch of abrasive particles of any one of items 2, 4, 5, and 6, wherein the MQMPD is at least about 49%, at least about 50%, at least about 52%, at least about 54%, at least about 56%, at least about 58%.

Item 8. The shaped abrasive particle or batch of abrasive particles of any one of items 2, 4, 5 and 6, wherein the MQMPD is not greater than about 99%.

Item 9. The shaped abrasive particle or batch of abrasive particles of any one of items 2 and 6, wherein the shaped abrasive particle comprises a major surface-to-side surface grinding orientation percent difference (MSGPD) of at least about 40%.

Item 10. The shaped abrasive particle or batch of abrasive particles of any one of items 1, 3, 5, and 9, wherein the shaped abrasive particle comprises a major surface-to-side surface grinding orientation percent difference (MSGPD) of at least about 42%, at least about 44%, at least about 46%, at least about 48%, at least about 50%, at least about 52%, at least about 54%, at least about 55%, at least about 56%, at least about 57%, at least about 58%, at least about 59%.

Item 11. The shaped abrasive particle or batch of abrasive particles of any one of items 1, 3, 5, and 9, wherein the shaped abrasive particle comprises a major surface-to-side surface grinding orientation percent difference (MSGPD) of not greater than about 99%.

Item 12. The shaped abrasive particle or batch of abrasive particles of any one of items 1, 2, 3, 4, and 5, wherein the shaped abrasive particle comprises a body having a length (l), a width (w), and a height (h), wherein the width>length, the length>height, and the width>height.

Item 13. The shaped abrasive particle or batch of abrasive particles of any one of items 1, 2, 3, 4, and 5, wherein the shaped abrasive particle comprises a body having a first major surface, a second major surface, and at least one side surface extending between the first major surface and the second major surface.

Item 14. The shaped abrasive particle or batch of abrasive particles of any one of items 12 and 13, wherein the body comprises a major surface corner radius of curvature of at least about 100 microns, at least about 120 microns, at least about 140 microns, at least about 160 microns, 180 microns, at least about 190 microns, at least about 200 microns, at least about 210 microns, at least about 220 microns, at least about 230 microns at least about 240 microns, at least about 250 microns, at least about 260 microns at least about 270 microns, at least about 280 microns, at least about 290 microns.

Item 15. The shaped abrasive particle or batch of abrasive particles of any one of items 12 and 13, wherein the body comprises a major surface corner radius of curvature of at not greater than about 800 microns, not greater than about 700 microns, not greater than about 600 microns, not greater than about 500 microns, not greater than about 400 microns.

Item 16. The shaped abrasive particle or batch of abrasive particles of any one of items 12 and 13, wherein the body comprises a side surface corner radius of curvature of not greater than about 800 microns, such as not greater than about 700 microns, not greater than about 600 microns, not greater than about 500 microns, not greater than about 400 microns, not greater than about 300 microns, not greater than about 200 microns, not greater than about 280 microns, not greater than about 260 microns, not greater than about 240 microns, not greater than about 220 microns, not greater than about 200 microns, not greater than about 180 microns, not greater than about 160 microns, not greater than about 140 microns, not greater than about 100 microns, not greater than about 80 microns, or even not greater than about 60 microns.

Item 17. The shaped abrasive particle or batch of abrasive particles of any one of items 12 and 13, wherein the body comprises a side surface corner radius of curvature of at least about 1 micron.

Item 18. The shaped abrasive particle or batch of abrasive particles of any one of items 12 and 13, wherein the body comprises a ratio (SSCR/MSCR) of a side surface corner radius of curvature (SSCR) to a major surface corner radius of curvature (MSCR) of not greater than about 1, not greater than about 0.9, not greater than about 0.8, not greater than about 0.7, not greater than about 0.6, not greater than about 0.5, not greater than about 0.4, not greater than about 0.2, not greater than about 0.1, not greater than about 0.09.

Item 19. The shaped abrasive particle or batch of abrasive particles of any one of items 12 and 13, wherein the body comprises a ratio (SSCR/MSCR) of a side surface corner radius of curvature (SSCR) to a major surface corner radius of curvature (MSCR) of at least about 0.001, at least about 0.005, at least about 0.01

Item 20. The shaped abrasive particle or batch of abrasive particles of any one of items 12 and 13, wherein the body comprises a major surface corner radius of curvature greater than a side surface corner radius of curvature.

Item 21. The shaped abrasive particle or batch of abrasive particles of any one of items 12 and 13, wherein the height (h) is at least about 20% of the width (w), at least about 25%, at least about 30%, at least about 33%, and not greater than about 80%, not greater than about 76%, not greater than about 73%, not greater than about 70%, not greater than about 68% of the width, not greater than about 56% of the width, not greater than about 48% of the width, not greater than about 40% of the width.

Item 22. The shaped abrasive particle or batch of abrasive particles of any one of items 12 and 13, wherein the height (h) is at least about 400 microns, at least about 450 microns, at least about 475 microns, at least about 500 microns, and not greater than about 3 mm, not greater than about 2 mm, not greater than about 1.5 mm, not greater than about 1 mm, not greater than about 800 microns.

Item 23. The shaped abrasive particle or batch of abrasive particles of any one of items 12 and 13, wherein the width is at least about 600 microns, at least about 700 microns, at least about 800 microns, at least about 900 microns, and not greater than about 4 mm, not greater than about 3 mm, not greater than about 2.5 mm, not greater than about 2 mm.

Item 24. The shaped abrasive particle or batch of abrasive particles of any one of items 12 and 13, wherein the body comprises a percent flashing of not greater than about 20%, not greater than about 18%, not greater than about 15%, not greater than about 12%, not greater than about 10%, not greater than about 8%, not greater than about 6%, not greater than about 4%, and at least about 1%.

Item 25. The shaped abrasive particle or batch of abrasive particles of any one of items 12 and 13, wherein the body comprises a dishing value (d) of not greater than about 2, not greater than about 1.9, not greater than about 1.8, not greater than about 1.7, not greater than about 1.6, not greater than about 1.5, not greater than about 1.2, and at least about 0.9, at least about 1.0.

Item 26. The shaped abrasive particle or batch of abrasive particles of any one of items 12 and 13, wherein the body comprises a primary aspect ratio of width:length of at least about 1:1 and not greater than about 10:1.

Item 27. The shaped abrasive particle or batch of abrasive particles of any one of items 12 and 13, wherein the body comprises a secondary aspect ratio defined by a ratio of width:height within a range between about 5:1 and about 1:1.

Item 28. The shaped abrasive particle or batch of abrasive particles of any one of items 12 and 13, wherein the body comprises a tertiary aspect ratio defined by a ratio of length:height within a range between about 6:1 and about 1.5:1.

Item 29. The shaped abrasive particle or batch of abrasive particles of any one of items 12 and 13, wherein the body comprises a two-dimensional polygonal shape as viewed in a plane defined by a length and width, wherein the body comprises a shape selected from the group consisting of triangular, quadrilateral, rectangular, trapezoidal, pentagonal, hexagonal, heptagonal, octagonal, and a combination thereof, wherein the body comprises a two-dimensional shape as viewed in a plane defined by a length and a width of the body selected from the group consisting of ellipsoids, Greek alphabet characters, Latin alphabet characters, Russian alphabet characters, triangles, and a combination thereof.

Item 30. The shaped abrasive particle or batch of abrasive particles of item 13, wherein the first major surface defines an area different than the second major surface, wherein the first major surface defines an area greater than an area defined by the second major surface, wherein the first major surface defines an area less than an area defined by the second major surface.

Item 31. The shaped abrasive particle or batch of abrasive particles of any one of items 12 and 13, wherein the body is essentially free of a binder, wherein the body is essentially free of an organic material.

Item 32. The shaped abrasive particle or batch of abrasive particles of any one of items 12 and 13, wherein the body comprises a polycrystalline material, wherein the polycrystalline material comprises grains, wherein the grains are selected from the group of materials consisting of nitrides, oxides, carbides, borides, oxynitrides, diamond, and a combination thereof, wherein the grains comprise an oxide selected from the group of oxides consisting of aluminum oxide, zirconium oxide, titanium oxide, yttrium oxide, chromium oxide, strontium oxide, silicon oxide, and a combination thereof, wherein the grains comprise alumina, wherein the grains consist essentially of alumina.

Item 33. The shaped abrasive particle or batch of abrasive particles of any one of items 12 and 13, wherein the body is formed from a seeded sol gel.

Item 34. The shaped abrasive particle or batch of abrasive particles of any one of items 12 and 13, wherein the body comprises a polycrystalline material having an average grain size not greater than about 1 micron.

Item 35. The shaped abrasive particle or batch of abrasive particles of any one of items 12 and 13, wherein the body is a composite comprising at least about 2 different types of abrasive grains.

Item 36. The shaped abrasive particle or batch of abrasive particles of any one of items 12 and 13, wherein the body comprises an additive, wherein the additive comprises an oxide, wherein the additive comprises a metal element, wherein the additive comprises a rare-earth element.

Item 37. The shaped abrasive particle or batch of abrasive particles of item 36, wherein the additive comprises a dopant material, wherein the dopant material includes an element selected from the group consisting of an alkali element, an alkaline earth element, a rare earth element, a transition metal element, and a combination thereof, wherein the dopant material comprises an element selected from the group consisting of hafnium, zirconium, niobium, tantalum, molybdenum, vanadium, lithium, sodium, potassium, magnesium, calcium, strontium, barium, scandium, yttrium, lanthanum, cesium, praseodymium, chromium, cobalt, iron, germanium, manganese, nickel, titanium, zinc, and a combination thereof.

Item 38. The shaped abrasive particle or batch of abrasive particles of any one of items 1, 2, 3, and 4, further comprising a major surface grinding efficiency and a side surface grinding efficiency, wherein the major surface grinding efficiency is less than the side surface grinding efficiency.

Item 39. The shaped abrasive particle or batch of abrasive particles of any one of items 1, 2, 3, and 4, further comprising a major surface grinding efficiency and a side surface grinding efficiency, wherein the major surface grinding efficiency is greater than the side surface grinding efficiency.

Item 40. The shaped abrasive particle or batch of abrasive particles of any one of items 1, 2, 3, and 4, further comprising a major surface grinding efficiency upper quartile value (MSUQ), a major surface grinding efficiency median value (MSM), a major surface grinding efficiency lower quartile value (MSLQ), a side surface grinding efficiency upper quartile value (SSUQ), a side surface grinding efficiency median value (SSM), a side surface grinding efficiency lower quartile (SSLQ), and a major surface grinding efficiency time variance (MSTV).

Item 41. The shaped abrasive particle item 5, further comprising a major surface grinding efficiency upper quartile value (MSUQ), a major surface grinding efficiency lower quartile value (MSLQ), a side surface grinding efficiency upper quartile value (SSUQ), a side surface grinding efficiency median value (SSM), and a side surface grinding efficiency lower quartile (SSLQ).

Item 42. The shaped abrasive particle or batch of abrasive particles of any one of items 40 and 41, further comprising a maximum quartile difference (MQD) of at least about 6 kN/mm2, at least about 6.2 kN/mm2, at least about 6.5 kN/mm2, at least about 6.8 kN/mm2, at least about 7 kN/mm2, at least about 7.5 kN/mm2, at least about 8 kN/mm2, at least about 9 kN/mm2, at least about 10 kN/mm2, at least about 12 kN/mm2.

Item 43. The shaped abrasive particle or batch of abrasive particles of any one of items 40 and 41, further comprising a major surface-to-side surface quartile percent overlap (MSQPO) of not greater than about 11%, not greater than about 10%, not greater than about 9%, not greater than about 8%, not greater than about 7%, not greater than about 6%, not greater than about 5%, not greater than about 4%, not greater than about 3%, not greater than about 2%, not greater than about 1%.

Item 44. The shaped abrasive particle or batch of abrasive particles of any one of items 40 and 41, further comprising a major surface grinding efficiency median value and side surface grinding efficiency median value difference (MSMD) of at least about 1.9 kN/mm2, at least about 2 kN/mm2, at least about 2.3 kN/mm2, at least about 2.5 kN/mm2, at least about 2.7 kN/mm2, at least about 3 kN/mm2, at least about 3.5 kN/mm2, at least about 4 kN/mm2, at least about 4.5 kN/mm2, at least about 5 kN/mm2, at least about 6 kN/mm2.

Item 45. The shaped abrasive particle or batch of abrasive particles of any one of items 40 and 41, further comprising a major surface-to-side surface upper quartile percent difference (MSUQPD) of at least about 54%, at least about 55%, at least about 56%, at least about 57%, at least about 58%, at least about 60%, at least about 63%, at least about 65%, at least about 70%.

Item 46. The shaped abrasive particle or batch of abrasive particles of any one of items 40 and 41, further comprising a major surface-to-side surface lower quartile percent difference (MSLQPD) of at least about 28%, at least about 30%, at least about 32%, at least about 35%, at least about 37%, at least about 40%, at least about 42%, at least about 45%, at least about 47% at least about 50%, at least about 52%, at least about 55%, at least about 57%.

Item 47. The shaped abrasive particle or batch of abrasive particles of any one of items 40 and 41, wherein the major surface grinding efficiency upper quartile value (MSUQ) is not greater than about 8.3 kN/mm2, not greater than about 8 kN/mm2, not greater than about 7.8 kN/mm2, not greater than about 7.5 kN/mm2, not greater than about 7.2 kN/mm2, not greater than about 7 kN/mm2, not greater than about 6.8 kN/mm2, not greater than about 6.5 kN/mm2, not greater than about 6.2 kN/mm2, not greater than about 6 kN/mm2, not greater than about 5.5 kN/mm2, not greater than about 5.2 kN/mm2, not greater than about 4 kN/mm2.

Item 48. The shaped abrasive particle or batch of abrasive particles of any one of items 40 and 41, wherein the major surface grinding efficiency time variance (MSTV) is not greater than about 2 kN/mm2, not greater than about 1.8 kN/mm2, not greater than about 1.5 kN/mm2, not greater than about 1.2 kN/mm2, not greater than about 1.1 kN/mm2, not greater than about 1 kN/mm2, not greater than about 0.9 kN/mm2, not greater than about 0.8 kN/mm2.

Item 49. The shaped abrasive particle or batch of abrasive particles of any one of items 40 and 41, wherein the major surface grinding efficiency upper quartile value (MSUQ) is at least about 0.1 kN/mm2.

Item 50. The shaped abrasive particle or batch of abrasive particles of item 40, wherein the major surface grinding efficiency median value (MSM) is less than the major surface grinding efficiency upper quartile value (MSUQ), wherein the major surface grinding efficiency median value (MSM) is not greater than about 8 kN/mm2, not greater than about 7.8 kN/mm2, not greater than about 7.5 kN/mm2, not greater than about 7.2 kN/mm2, not greater than about 7 kN/mm2, not greater than about 6.8 kN/mm2, not greater than about 6.5 kN/mm2, not greater than about 6.2 kN/mm2, not greater than about 6 kN/mm2, not greater than about 5.8 kN/mm2, not greater than about 5.5 kN/mm2, not greater than about 5.2 kN/mm2, not greater than about 5 kN/mm2, not greater than about 4.8 kN/mm2, not greater than about 4.6 kN/mm2, not greater than about 4.2 kN/mm2, not greater than about 4 kN/mm2.

Item 51. The shaped abrasive particle or batch of abrasive particles of any one of items 5 and 50, wherein the major surface grinding efficiency median value (MSM) is not greater than about 3.8 kN/mm2, not greater than about 3.6 kN/mm2, not greater than about 3.2 kN/mm2, not greater than about 3 kN/mm2, not greater than about 2.8 kN/mm2, not greater than about 2.6 kN/mm2.

Item 52. The shaped abrasive particle or batch of abrasive particles of any one of items 5 and 50, wherein the major surface grinding efficiency median value (MSM) is at least about 0.1 kN/mm2.

Item 53. The shaped abrasive particle or batch of abrasive particles of any one of items 40 and 41, wherein the major surface grinding efficiency lower quartile value (MSLQ) is less than the major surface grinding efficiency median value (MSM), wherein the major surface grinding efficiency lower quartile value (MSLQ) is not greater than about 8 kN/mm2, not greater than about 7 kN/mm2, not greater than about 6 kN/mm2, not greater than about 5 kN/mm2, not greater than about 4 kN/mm2, not greater than about kN/mm2, not greater than about 6.5 kN/mm2, not greater than about 6.2 kN/mm2, not greater than about 6 kN/mm2, not greater than about 5.8 kN/mm2, not greater than about 5.5 kN/mm2, not greater than about 5.2 kN/mm2, not greater than about 5 kN/mm2, not greater than about 4.8 kN/mm2, not greater than about 4.6 kN/mm2, not greater than about 4.2 kN/mm2, not greater than about 4 kN/mm2, not greater than about 3.8 kN/mm2, not greater than about 3.6 kN/mm2, not greater than about 3.2 kN/mm2, not greater than about 3 kN/mm2, not greater than about 2.8 kN/mm2, not greater than about 2.6 kN/mm2, not greater than about 2.2 kN/mm2, not greater than about 2 kN/mm2, not greater than about 1.9 kN/mm2.

Item 54. The shaped abrasive particle or batch of abrasive particles of any one of items 40 and 41, wherein the major surface grinding efficiency lower quartile value (MSLQ) is at least about 0.1 kN/mm2.

Item 55. The shaped abrasive particle or batch of abrasive particles of item 40, wherein the side surface grinding efficiency upper quartile value (SSUQ) is at least about 4.5 kN/mm2, at least about 5 kN/mm2, at least about 5.5 kN/mm2, at least about 6 kN/mm2, at least about 6.5 kN/mm2, at least about 7 kN/mm2, at least about 7.5 kN/mm2, at least about 8 kN/mm2, at least about 8.5 kN/mm2, at least about 9 kN/mm2, at least about 10 kN/mm2, at least about 15 kN/mm2, at least about 20 kN/mm2, at least about 25 kN/mm2.

Item 56. The shaped abrasive particle or batch of abrasive particles of any one of items 40 and 41, wherein the side surface grinding efficiency upper quartile value (SSUQ) is not greater than about 100 kN/mm2.

Item 57. The shaped abrasive particle or batch of abrasive particles of item 40, wherein the side surface grinding efficiency median value (SSM) is less than the side surface grinding efficiency upper quartile value (SSUQ), wherein the side surface grinding efficiency median value (SSM) is at least about 3 kN/mm2, at least about 3.2 kN/mm2, at least about 3.5 kN/mm2, at least about 3.7 kN/mm2, at least about 4 kN/mm2, at least about 4.2 kN/mm2, at least about 4.5 kN/mm2, at least about 4.7 kN/mm2, at least about 5 kN/mm2, at least about 5.2 kN/mm2, at least about 5.5 kN/mm2, at least about 5.7 kN/mm2, at least about 6 kN/mm2, at least about 6.2 kN/mm2, at least about 6.5 kN/mm2, at least about 7 kN/mm2, at least about 8 kN/mm2, at least about 9 kN/mm2, at least about 10 kN/mm2.

Item 58. The shaped abrasive particle or batch of abrasive particles of any one of items 40 and 41, wherein the side surface grinding efficiency median value (SSM) is not greater than about 100 kN/mm2.

Item 59. The shaped abrasive particle or batch of abrasive particles of item 40, wherein the side surface grinding efficiency lower quartile value (SSLQ) is less than the side surface grinding efficiency median value (SSM), wherein the side surface grinding efficiency lower quartile value (SSLQ) is at least about 2.5 kN/mm2, at least about 2.7 kN/mm2, at least about 3 kN/mm2, at least about 3.1 kN/mm2, at least about 3.3 kN/mm2, at least about 3.5 kN/mm2, at least about 3.6 kN/mm2, at least about 3.8 kN/mm2, at least about 4 kN/mm2, at least about 5 kN/mm2, at least about 6 kN/mm2.

Item 60. The shaped abrasive particle or batch of abrasive particles of any one of items 40 and 41, wherein the side surface grinding efficiency lower quartile value (SSLQ) is not greater than about 100 kN/mm2.

Item 61. The batch of abrasive particles of any one of items 3 and 4, wherein the first portion comprises a majority of a total number of shaped abrasive particles of the batch.

Item 62. The batch of abrasive particles of any one of items 3 and 4, wherein the first portion comprises a minority of a total number of shaped abrasive particles of the batch.

Item 63. The batch of abrasive particles of any one of items 3 and 4, wherein the first portion defines at least 1% of a total number of shaped abrasive particles of the batch.

Item 64. The batch of abrasive particles of any one of items 3 and 4, wherein the first portion defines not greater than about 99% of a total number of shaped abrasive particles of the batch.

Item 65. The batch of abrasive particles of any one of items 3 and 4, wherein the batch further comprises a second portion of shaped abrasive particles, wherein the second portion of shaped abrasive particles have a second grinding efficiency characteristic different than a first grinding efficiency characteristic of the first portion, wherein the second grinding efficiency characteristic is selected from the group consisting of: a major surface grinding efficiency upper quartile value (MSUQ); a major surface grinding efficiency median value (MSM); a major surface grinding efficiency lower quartile value (MSLQ); a side surface grinding efficiency upper quartile value (SSUQ); a side surface grinding efficiency median value (SSM); a side surface grinding efficiency lower quartile value (SSLQ); a major surface-to-side surface grinding orientation percent difference (MSGPD); a maximum quartile-to-median percent difference (MQMPD); a maximum quartile difference (MQD); a major surface-to-side surface quartile percent overlap (MSQPO); a major surface grinding efficiency median value and side surface grinding efficiency median value difference (MSMD); a major surface-to-side surface upper quartile percent difference (MSUQPD); a major surface-to-side surface lower quartile percent difference (MSLQPD); a major surface grinding efficiency time variance (MSTV); and a combination thereof.

Item 66. The batch of abrasive particles of any one of items 3 and 4, wherein the batch of abrasive particles are part of a fixed abrasive article, wherein the fixed abrasive article is selected from the group consisting of bonded abrasive articles, coated abrasive articles, and a combination thereof.

Item 67. The batch of abrasive particles of any one of items 3 and 4, wherein the batch of abrasive particles are part of a fixed abrasive article, wherein the fixed abrasive article comprises a coated abrasive article, and wherein the first portion of the batch includes a plurality of shaped abrasive particles, each of the shaped abrasive particles of the plurality of shaped abrasive particles are arranged in a controlled orientation relative to a backing, the controlled orientation including at least one of a predetermined rotational orientation, a predetermined lateral orientation, and a predetermined longitudinal orientation.

Item 68. The batch of abrasive particles of any one of items 3 and 4, wherein a majority of the first portion of shaped abrasive particles are coupled to a backing in a side orientation, wherein at least about 55% of the shaped abrasive particles of the first portion are coupled to the backing in a side orientation, at least about 60%, at least about 65%, at least about 70%, at least about 75%, at least about 77%, at least about 80%, at least about 82%, and not greater than about 99%.

Item 69. The batch of abrasive particles of any one of items 3 and 4, wherein the plurality of shaped abrasive particles of the first portion define an open coat, wherein the plurality of shaped abrasive particles of the first portion define a closed coat, wherein the open coat comprises a coating density of not greater than about 70 particles/cm2.

Item 70. The batch of abrasive particles of any one of items 3 and 4, wherein the batch of abrasive particles are part of a coated abrasive article, wherein the first portion including the plurality of shaped abrasive particles overlies a backing, wherein the backing comprises a woven material, wherein the backing comprises a non-woven material, wherein the backing comprises an organic material, wherein the backing comprises a polymer, wherein the backing comprises a material selected from the group consisting of cloth, paper, film, fabric, fleeced fabric, vulcanized fiber, woven material, non-woven material, webbing, polymer, resin, phenolic resin, phenolic-latex resin, epoxy resin, polyester resin, urea formaldehyde resin, polyester, polyurethane, polypropylene, polyimides, and a combination thereof.

Item 71. The batch of abrasive particles of item 70, wherein the backing comprises an additive chosen from the group consisting of catalysts, coupling agents, curants, anti-static agents, suspending agents, anti-loading agents, lubricants, wetting agents, dyes, fillers, viscosity modifiers, dispersants, defoamers, and grinding agents.

Item 72. The batch of abrasive particles of item 70, further comprising an adhesive layer overlying the backing, wherein the adhesive layer comprises a make coat, wherein the make coat overlies the backing, wherein the make coat is bonded directly to a portion of the backing, wherein the make coat comprises an organic material, wherein the make coat comprises a polymeric material, wherein the make coat comprises a material selected from the group consisting of polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and a combination thereof.

Item 73. The batch of abrasive particles of item 72, wherein the adhesive layer comprises a size coat, wherein the size coat overlies a portion of the plurality of shaped abrasive particles, wherein the size coat overlies a make coat, wherein the size coat is bonded directly to a portion of the first abrasive particle, wherein the size coat comprises an organic material, wherein the size coat comprises a polymeric material, wherein the size coat comprises a material selected from the group consisting of polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and a combination thereof.

Item 74. An abrasive article comprising: a backing: a batch of abrasive particles comprising a first portion including a plurality of shaped abrasive particles overlying the backing, wherein the plurality of shaped abrasive particles of the first portion comprise at least one first grinding efficiency characteristic of: a major surface-to-side surface grinding orientation percent difference (MSGPD) of at least about 40%; a maximum quartile-to-median percent difference (MQMPD) of at least about 48% a major surface grinding efficiency median value (MSM) of not greater than about 4 kN/mm2; and a combination thereof.

Item 75. The abrasive article of item 74, wherein a majority of the plurality of shaped abrasive particles of the first portion of the batch are arranged in a side orientation relative to the backing.

Item 76. The abrasive article of item 74, wherein a majority of the plurality of shaped abrasive particles of the first portion of the batch comprise a substantially random rotational orientation relative to the backing.

Item 77. The abrasive article of item 74, wherein a majority of the plurality of shaped abrasive particles of the first portion of the batch comprise a substantially random rotational orientation relative to a predetermined grinding direction.

Item 78. The abrasive article of item 74, wherein at least about 55% of the plurality of shaped abrasive particles of the first portion are oriented in a side orientation, at least about 60%, at least about 65%, at least about 70%, at least about 75%, at least about 77%, at least about 80%, at least about 82%, and not greater than about 99%.

Item 79. The abrasive article of item 74, wherein the plurality of shaped abrasive particles of the first portion define an open coat, wherein the plurality of shaped abrasive particles of the first portion define a closed coat, wherein the open coat comprises a coating density of not greater than about 70 particles/cm2, not greater than about 65 particles/cm2, not greater than about 60 particles/cm2, not greater than about 55 particles/cm2, not greater than about 50 particles/cm2, at least about 5 particles/cm2, at least about 10 particles/cm2.

Item 80. The abrasive article of item 74, wherein the backing comprises a woven material, wherein the backing comprises a non-woven material, wherein the backing comprises an organic material, wherein the backing comprises a polymer, wherein the backing comprises a material selected from the group consisting of cloth, paper, film, fabric, fleeced fabric, vulcanized fiber, woven material, non-woven material, webbing, polymer, resin, phenolic resin, phenolic-latex resin, epoxy resin, polyester resin, urea formaldehyde resin, polyester, polyurethane, polypropylene, polyimides, and a combination thereof.

Item 81. The abrasive article of item 74, wherein the backing comprises an additive chosen from the group consisting of catalysts, coupling agents, curants, anti-static agents, suspending agents, anti-loading agents, lubricants, wetting agents, dyes, fillers, viscosity modifiers, dispersants, defoamers, and grinding agents.

Item 82. The abrasive article of item 74, wherein further comprising an adhesive layer overlying the backing, wherein the adhesive layer comprises a make coat, wherein the make coat overlies the backing, wherein the make coat is bonded directly to a portion of the backing, wherein the make coat comprises an organic material, wherein the make coat comprises a polymeric material, wherein the make coat comprises a material selected from the group consisting of polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and a combination thereof.

Item 83. The abrasive article of item 82, wherein the adhesive layer comprises a size coat, wherein the size coat overlies a portion of the plurality of shaped abrasive particles, wherein the size coat overlies a make coat, wherein the size coat is bonded directly to a portion of the first abrasive particle, wherein the size coat comprises an organic material, wherein the size coat comprises a polymeric material, wherein the size coat comprises a material selected from the group consisting of polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and a combination thereof.

Item 84. The abrasive article of item 74, wherein the plurality of shaped abrasive particles of the first portion further comprise a first grinding efficiency characteristic selected from the group consisting of: a major surface grinding efficiency upper quartile value (MSUQ) not greater than about 8.3 kN/mm2; a major surface grinding efficiency lower quartile value (MSLQ) not greater than about 8 kN/mm2; a side surface grinding efficiency upper quartile value (SSUQ) at least about 4.5 kN/mm2; a side surface grinding efficiency median value (SSM) at least about 3 kN/mm2; a side surface grinding efficiency lower quartile value (SSLQ) at least about 2.5 kN/mm2; a maximum quartile difference (MQD) at least about 6 kN/mm2; a major surface-to-side surface quartile percent overlap (MSQPO) of not greater than about 11%, a major surface grinding efficiency median value and side surface grinding efficiency median value difference (MSMD) of at least about 1.9 kN/mm2; a major surface-to-side surface upper quartile percent difference (MSUQPD) of at least about 54%; a major surface-to-side surface lower quartile percent difference (MSLQPD) of at least about 28%; a major surface grinding efficiency time variance (MSTV) is not greater than about 2 kN/mm2; and a combination thereof.

Item 85. The abrasive article of item 84, wherein the batch further comprises a second portion of shaped abrasive particles, wherein the second portion of shaped abrasive particles have a second grinding efficiency characteristic different than a first grinding efficiency characteristic of the first portion, wherein the second grinding efficiency characteristic is selected from the group consisting of: a major surface grinding efficiency upper quartile value (MSUQ); a major surface grinding efficiency median value (MSM); a major surface grinding efficiency lower quartile value (MSLQ); a side surface grinding efficiency upper quartile value (SSUQ); a side surface grinding efficiency median value (SSM); a side surface grinding efficiency lower quartile value (SSLQ); a major surface-to-side surface grinding orientation percent difference (MSGPD); a maximum quartile-to-median percent difference (MQMPD); a maximum quartile difference (MQD); a major surface-to-side surface quartile percent overlap (MSQPO); a major surface grinding efficiency median value and side surface grinding efficiency median value difference (MSMD); a major surface-to-side surface upper quartile percent difference (MSUQPD); a major surface-to-side surface lower quartile percent difference (MSLQPD); wherein the major surface grinding efficiency time variance (MSTV); and a combination thereof.

Item 86. The abrasive article of item 85, wherein at least one of the first grinding efficiency characteristics of the first portion is different as compared to a corresponding second grinding efficiency characteristic of the second portion by at least about 2%, at least about 5%, at least about 8%, at least about 10%, at least about 12%, at least about 25%, at least about 18%, at least about 20%, at least about 22%, at least about 25%.

Item 87. The abrasive article of item 85, wherein at least one of the first grinding efficiency characteristics of the first portion is greater than a corresponding second grinding efficiency characteristic of the second portion by at least about 2%, at least about 5%, at least about 8%, at least about 10%, at least about 12%, at least about 25%, at least about 18%, at least about 20%, at least about 22%, at least about 25%.

Item 88. The abrasive article of item 85, wherein at least one of the first grinding efficiency characteristics of the first portion is less than a corresponding second grinding efficiency characteristic of the second portion by at least about 2%, at least about 5%, at least about 8%, at least about 10%, at least about 12%, at least about 25%, at least about 18%, at least about 20%, at least about 22%, at least about 25%.

Item 89. The abrasive article of item 74, wherein the first portion comprises a majority of a total number of shaped abrasive particles of the batch.

Item 90. The abrasive article of item 74, wherein the first portion comprises a minority of a total number of shaped abrasive particles of the batch.

Item 91. The abrasive article of item 74, wherein the first portion defines at least 1% of a total number of shaped abrasive particles of the batch.

Item 92. The abrasive article of item 74, wherein the first portion defines not greater than about 99% of a total number of shaped abrasive particles of the batch.

Item 93. The abrasive article of item 74, wherein the batch further comprises a second portion of abrasive particles, the second portion including crushed abrasive particles having random shapes.

Item 94. The abrasive article of item 74, wherein the batch further comprises a second portion of abrasive particles, the second portion including diluent abrasive particles.

Item 95. A method comprising: removing material from a workpiece by moving an abrasive article relative to a surface of the workpiece, the abrasive article comprising: a backing; and a batch of abrasive particles comprising a first portion including a plurality of shaped abrasive particles overlying the backing, wherein the plurality of shaped abrasive particles of the first portion comprise at least one first grinding efficiency characteristic of: a major surface-to-side surface grinding orientation percent difference (MSGPD) of at least about 40%; a maximum quartile-to-median percent difference (MQMPD) of at least about 48% a major surface grinding efficiency median value (MSM) of not greater than about 4 kN/mm2; and a combination thereof.

Item 96. The method of item 95, wherein the fixed abrasive article comprises a coated abrasive article including a single layer of the batch overlying the backing.

Item 97. The method of item 95, wherein a majority of the plurality of shaped abrasive particles of the first portion of the batch are arranged in a side orientation relative to the backing.

Item 98. The method of item 95, wherein a majority of the plurality of shaped abrasive particles of the first portion of the batch comprise a substantially random rotational orientation relative to the backing.

Item 99. The method of item 95, wherein a majority of the plurality of shaped abrasive particles of the first portion of the batch comprise a substantially random rotational orientation relative to a predetermined grinding direction.

Item 100. The method of item 95, wherein at least about 55% of the plurality of shaped abrasive particles of the first portion are oriented in a side orientation, at least about 60%, at least about 65%, at least about 70%, at least about 75%, at least about 77%, at least about 80%, at least about 82%, and not greater than about 99%.

Item 101. The method of item 95, wherein the plurality of shaped abrasive particles of the first portion define an open coat, wherein the open coat comprises a coating density of not greater than about 70 particles/cm2, not greater than about 65 particles/cm2, not greater than about 60 particles/cm2, not greater than about 55 particles/cm2, not greater than about 50 particles/cm2, at least about 5 particles/cm2, at least about 10 particles/cm2.

Item 102. The method of item 95, wherein the plurality of shaped abrasive particles of the first portion define a closed coat, wherein the closed coat comprises a coating density of at least about 75 particles/cm2, at least about 80 particles/cm2, at least about 85 particles/cm2, at least about 90 particles/cm2, at least about 100 particles/cm2.

Item 103. The method of item 95, wherein the backing comprises a woven material, wherein the backing comprises a non-woven material, wherein the backing comprises an organic material, wherein the backing comprises a polymer, wherein the backing comprises a material selected from the group consisting of cloth, paper, film, fabric, fleeced fabric, vulcanized fiber, woven material, non-woven material, webbing, polymer, resin, phenolic resin, phenolic-latex resin, epoxy resin, polyester resin, urea formaldehyde resin, polyester, polyurethane, polypropylene, polyimides, and a combination thereof.

Item 104. The method of item 95, wherein the backing comprises an additive chosen from the group consisting of catalysts, coupling agents, curants, anti-static agents, suspending agents, anti-loading agents, lubricants, wetting agents, dyes, fillers, viscosity modifiers, dispersants, defoamers, and grinding agents.

Item 105. The method of item 95, further comprising an adhesive layer overlying the backing, wherein the adhesive layer comprises a make coat, wherein the make coat overlies the backing, wherein the make coat is bonded directly to a portion of the backing, wherein the make coat comprises an organic material, wherein the make coat comprises a polymeric material, wherein the make coat comprises a material selected from the group consisting of polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and a combination thereof.

Item 106. The method of item 95, wherein the adhesive layer comprises a size coat, wherein the size coat overlies a portion of the plurality of shaped abrasive particles, wherein the size coat overlies a make coat, wherein the size coat is bonded directly to a portion of the first abrasive particle, wherein the size coat comprises an organic material, wherein the size coat comprises a polymeric material, wherein the size coat comprises a material selected from the group consisting of polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and a combination thereof.

Item 107. The method of item 95, wherein the plurality of shaped abrasive particles of the first portion further comprise a first grinding efficiency characteristic selected from the group consisting of: a major surface grinding efficiency upper quartile value (MSUQ) not greater than about 8.3 kN/mm2; a major surface grinding efficiency lower quartile value (MSLQ) not greater than about 8 kN/mm2; a side surface grinding efficiency upper quartile value (SSUQ) at least about 4.5 kN/mm2; a side surface grinding efficiency median value (SSM) at least about 3 kN/mm2; a side surface grinding efficiency lower quartile value (SSLQ) at least about 2.5 kN/mm2; a maximum quartile difference (MQD) at least about 6 kN/mm2; a major surface-to-side surface quartile percent overlap (MSQPO) of not greater than about 11%, a major surface grinding efficiency median value and side surface grinding efficiency median value difference (MSMD) of at least about 1.9 kN/mm2; a major surface-to-side surface upper quartile percent difference (MSUQPD) of at least about 54%; a major surface-to-side surface lower quartile percent difference (MSLQPD) of at least about 28%; a major surface grinding efficiency time variance (MSTV) is not greater than about 2 kN/mm2; and a combination thereof.

Item 108. The method of item 95, wherein the first portion comprises a majority of a total number of shaped abrasive particles of the batch.

Item 109. The method of item 95, wherein the first portion comprises a minority of a total number of shaped abrasive particles of the batch.

Item 110. The method of item 95, wherein the first portion defines at least 1% of a total number of shaped abrasive particles of the batch.

Item 111. The method of item 95, wherein the first portion defines not greater than about 99% of a total number of shaped abrasive particles of the batch.

Item 112. The method of item 95, wherein the batch further comprises a second portion of abrasive particles, the second portion including crushed abrasive particles having random shapes.

Item 113. The method of item 95, wherein the batch further comprises a second portion of abrasive particles, the second portion including diluent abrasive particles.

What is claimed is:

1. A shaped abrasive particle comprising a major surface-to-side surface grinding orientation percent difference (MSGPD) of at least about 40%.

2. The shaped abrasive particle of claim 1, wherein the shaped abrasive particle comprises a maximum quartile-to-median percent difference (MQMPD) of at least about 48%.

3. The shaped abrasive particle of claim 2, wherein the MQMPD is not greater than about 99%.

4. The shaped abrasive particle of claim 1, wherein the MSGPD is not greater than about 99%.

5. The shaped abrasive particle of claim 1, wherein the shaped abrasive particle further comprises a first grinding efficiency characteristic selected from the group consisting of:
a major surface grinding efficiency upper quartile value (MSUQ) not greater than about 8.3 kN/mm²;
a major surface grinding efficiency lower quartile value (MSLQ) not greater than about 8 kN/mm²;
a side surface grinding efficiency upper quartile value (SSUQ) at least about 4.5 kN/mm²;
a side surface grinding efficiency median value (SSM) at least about 3 kN/mm²;
a side surface grinding efficiency lower quartile value (SSLQ) at least about 2.5 kN/mm²;
a maximum quartile difference (MQD) at least about 6 kN/mm²;
a major surface-to-side surface quartile percent overlap (MSQPO) of not greater than about 11%,
a major surface grinding efficiency median value and side surface grinding efficiency median value difference (MSMD) of at least about 1.9 kN/mm²;
a major surface-to-side surface upper quartile percent difference (MSUQPD) of at least about 54%;
a major surface-to-side surface lower quartile percent difference (MSLQPD) of at least about 28%;
a major surface grinding efficiency time variance (MSTV) is not greater than about 2 kN/mm²; and
a combination thereof.

6. The shaped abrasive particle of claim 1, wherein the shaped abrasive particle comprises a body having a length (l), a width (w), and a height (h), wherein the width>length, the length>height, and the width>height.

7. The shaped abrasive particle of claim 1, wherein the shaped abrasive particle comprises a body having a first major surface, a second major surface, and at least one side surface extending between the first major surface and the second major surface.

8. The shaped abrasive particle of claim 7, wherein the body comprises a major surface corner radius of curvature between about 100 microns and about 800 microns.

9. The shaped abrasive particle of claim 7, wherein the body comprises a side surface corner radius of curvature between about 1 micron and about 800 microns.

10. The shaped abrasive particle of claim 7, wherein the body comprises a ratio (SSCR/MSCR) of a side surface corner radius of curvature (SSCR) to a major surface corner radius of curvature (MSCR) between about 0.001 and about 1.

11. The shaped abrasive particle of claim 7, wherein the body comprises a major surface corner radius of curvature greater than a side surface corner radius of curvature.

12. The shaped abrasive particle of claim 6, wherein the body comprises a percent flashing of between about 1% and about 20%.

13. The shaped abrasive particle of claim 6, wherein the body comprises a two-dimensional polygonal shape as viewed in a plane defined by a length and a width of the body, wherein the body comprises a shape selected from the group consisting of triangular, quadrilateral, rectangular, trapezoidal, pentagonal, hexagonal, heptagonal, octagonal, and a combination thereof.

14. The shaped abrasive particle of claim 1, wherein the shaped abrasive particle is part of a fixed abrasive article.

15. A batch of abrasive particles comprising a first portion including a plurality of shaped abrasive particles having a major surface-to-side surface grinding orientation percent difference (MSGPD) of at least about 40%.

16. The batch of abrasive particles of claim 15, wherein the batch of abrasive particles are part of a fixed abrasive article.

17. The batch of abrasive particles of claim 15, wherein the plurality of shaped abrasive particles of the first portion further comprise a first grinding efficiency characteristic selected from the group consisting of:
a major surface grinding efficiency upper quartile value (MSUQ) not greater than about 8.3 kN/mm²;
a major surface grinding efficiency lower quartile value (MSLQ) not greater than about 8 kN/mm²;
a side surface grinding efficiency upper quartile value (SSUQ) at least about 4.5 kN/mm²;
a side surface grinding efficiency median value (SSM) at least about 3 kN/mm²;
a side surface grinding efficiency lower quartile value (SSLQ) at least about 2.5 kN/mm²;
a maximum quartile difference (MQD) at least about 6 kN/mm²;
a major surface-to-side surface quartile percent overlap (MSQPO) of not greater than about 11%,
a major surface grinding efficiency median value and side surface grinding efficiency median value difference (MSMD) of at least about 1.9 kN/mm²;
a major surface-to-side surface upper quartile percent difference (MSUQPD) of at least about 54%;
a major surface-to-side surface lower quartile percent difference (MSLQPD) of at least about 28%;
a major surface grinding efficiency time variance (MSTV) is not greater than about 2 kN/mm²; and
a combination thereof.

18. An abrasive article comprising:
a backing:
a batch of abrasive particles comprising a first portion including a plurality of shaped abrasive particles overlying the backing, wherein the plurality of shaped abrasive particles of the first portion comprise at least one first grinding efficiency characteristic of:
a major surface-to-side surface grinding orientation percent difference (MSGPD) of at least about 40%;
a maximum quartile-to-median percent difference (MQMPD) of at least about 48%;
a major surface grinding efficiency median value (MSM) of not greater than about 4 kN/mm²; and
a combination thereof.

19. The abrasive article of claim 18, wherein a majority of the plurality of shaped abrasive particles of the first portion of the batch are arranged in a side orientation relative to the backing.

20. The abrasive article of claim 18, wherein the batch further comprises a second portion of shaped abrasive particles, wherein the second portion of shaped abrasive particles have a second grinding efficiency characteristic different than the first grinding efficiency characteristic of the first portion, wherein the second grinding efficiency characteristic is selected from the group consisting of:
a major surface grinding efficiency upper quartile value (MSUQ);
a major surface grinding efficiency median value (MSM);
a major surface grinding efficiency lower quartile value (MSLQ);
a side surface grinding efficiency upper quartile value (SSUQ);
a side surface grinding efficiency median value (SSM);
a side surface grinding efficiency lower quartile value (SSLQ);
a major surface-to-side surface grinding orientation percent difference (MSGPD);
a maximum quartile-to-median percent difference (MQMPD);
a maximum quartile difference (MQD);
a major surface-to-side surface quartile percent overlap (MSQPO);
a major surface grinding efficiency median value and side surface grinding efficiency median value difference (MSMD);
a major surface-to-side surface upper quartile percent difference (MSUQPD);
a major surface-to-side surface lower quartile percent difference (MSLQPD);
wherein the major surface grinding efficiency time variance (MSTV); and
a combination thereof.
